(19) United States
(12) Patent Application Publication
(10) Pub. No.: US 2024/0372689 A1
(43) Pub. Date: Nov. 7, 2024

(54) METHOD, DEVICE AND COMPUTER READABLE MEDIUM FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 18/686,074

(22) PCT Filed: Sep. 26, 2021
(86) PCT No.: PCT/CN2021/120754

§ 371 Date: Feb. 23, 2024

(51) Int. Cl. H04L 5/00

(52) U.S. Cl. CPC H04L 5/0094; H04L 5/0053

(57) ABSTRACT

Embodiments of the present disclosure relate to methods, devices and computer readable media for communication. A terminal device receives an indication of a first transmission configuration indicator (TCI) state, wherein at least one reference signal (RS) in the first TCI state is associated with a first physical cell identity (ID), and the terminal device monitors a first physical downlink control channel (PDCCH) in a first monitoring occasion for a first search space based on a second TCI state or based on a quasi co-location (QCL), wherein at least one RS in the second TCI state and the QCL assumption is associated with a second physical cell ID; and the terminal device monitors a second PDCCH in a second monitoring occasion for a second search space based on a condition.

### TECHNICAL FIELD

Embodiments of the present disclosure generally relate to the field of telecommunication, and in particular, to methods, devices and computer storage media for communication.

### BACKGROUND

In the third generation partnership project (3GPP) meeting RAN #86, it is agreed to support enhancement on multi-beam operation, mainly targeting the frequency range 2 (FR2) while also applicable to the frequency range 1 (FR1). It is agreed to identify and specify features to facilitate more efficient (lower latency and overhead) downlink (DL) and uplink (UL) beam management for intra-cell and inter-cell. For example, it is proposed to support common beam(s) for data and control information transmission/reception for both DL and UL. It is also proposed to support a unified Transmission Configuration Indication (TCI) framework for DL and UL beam indication. Moreover, multi-input multi-output (MIMO) has been proposed, which includes features that facilitate utilization of a large number of antenna elements at a base station for both sub-6 GHZ and over 6-GHz frequency bands. Therefore, it is worth enhancing multi-beam operations.

### SUMMARY

In general, embodiments of the present disclosure provide methods, devices and computer storage media for communications.

In a first aspect, there is provided a method of communication. The method comprises: receiving, at a terminal device and from a network device, an indication of a first transmission configuration indicator (TCI) state, wherein at least one reference signal (RS) in the first TCI state is associated with a first physical cell identity (ID): monitoring a first physical downlink control channel (PDCCH) in a first monitoring occasion for a first search space based on a second TCI state or based on a quasi co-location (QCL), wherein at least one RS in the second TCI state and the QCL assumption is associated with a second physical cell ID; and monitoring a second PDCCH in a second monitoring occasion for a second search space based on a condition.

In a second aspect, there is provided a method of communication. The method comprises: receiving, at a terminal device and from a network device, a first indication of a first set of transmission configuration indicator (TCI) states for a first set of control resource sets (CORESETs): receiving, a second indication of a second set of TCI states for a second set of CORESETs; and performing one or two beam failure recovery procedures based on a condition.

In a third aspect, there is provided a method of communication. The method comprises: transmitting, at a network device and to a terminal device, an indication of a first transmission configuration indicator (TCI) state, wherein at least one reference signal (RS) in the first TCI state is associated with a first physical cell identity (ID): transmitting a first physical downlink control channel (PDCCH) in a first monitoring occasion for a first search space based on a second TCI state or based on a quasi co-location (QCL), wherein at least one RS in the second TCI state and the QCL assumption is associated with a second physical cell ID; and transmitting a second PDCCH in a second monitoring occasion for a second search space based on a condition.

In a fourth aspect, there is provided a method of communication. The method comprises: transmitting, at a network device and to a terminal device, a first indication of a first set of transmission configuration indicator (TCI) states for a first set of control resource sets (CORESETs): transmitting, a second indication of a second set of TCI states for a second set of CORESETs.

In a fifth aspect, there is provided a terminal device. The terminal device comprises a processor and a memory coupled to the processor. The memory stores instructions that when executed by the processor, cause the terminal device to perform the method according to the first aspect of the present disclosure.

In a sixth aspect, there is provided a terminal device. The terminal device comprises a processor and a memory coupled to the processor. The memory stores instructions that when executed by the processor, cause the terminal device to perform the method according to the second aspect of the present disclosure.

In a seventh aspect, there is provided a network device. The network device comprises a processor and a memory coupled to the processor. The memory stores instructions that when executed by the processor, cause the network to perform the method according to the third aspect of the present disclosure.

In an eighth aspect, there is provided a network device. The network device comprises a processor and a memory coupled to the processor. The memory stores instructions that when executed by the processor, cause the network device to perform the method according to the fourth aspect of the present disclosure.

In a ninth aspect, there is provided a computer readable medium having instructions stored thereon. The instructions, when executed on at least one processor, cause the at least one processor to perform the method according to the first, second, third or fourth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates a signaling flow for communication according to some example embodiments of the present disclosure:

FIGS. 3A-3B illustrate examples in accordance with some embodiments of the present disclosure;

FIG. 4 illustrates an example in accordance with some embodiments of the present disclosure:

FIG. 5 illustrates an example in accordance with some embodiments of the present disclosure:

FIG. 6 illustrates an example in accordance with some embodiments of the present disclosure:

FIG. 7 illustrates an example in accordance with some embodiments of the present disclosure:

FIG. 8 illustrates an example in accordance with some embodiments of the present disclosure:

FIG. 9 illustrates an example in accordance with some embodiments of the present disclosure:

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and play back appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the term “TRP” refers to an antenna array (with one or more antenna elements) available to the network device located at a specific geographical location. Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below:

Generally speaking, for uplink (UL) transmission, one TRP usually corresponds to one SRS resource set. As used herein, the term “single-TRP for UL” refers to that a single SRS resource set is used for performing related transmissions (such as, PUSCH transmissions), and the term “multi-TRP for UL” refers to that a plurality of SRS resource sets are used for performing related transmissions (such as, PUSCH transmissions).

As mentioned above, there are enhancements on multi-beam operation, mainly targeting FR2 while also applicable to FRI: a. Identify and specify features to facilitate more efficient (lower latency and overhead) DL/UL beam management for intra-cell and inter-cell scenarios to support higher UE speed and/or a larger number of configured TCI states: i. Common beam for data and control transmission/reception for DL and UL, especially for intra-band CA: ii. Unified TCI framework for DL and UL beam indication: iii. Enhancement on signaling mechanisms for the above features to improve latency and efficiency with more usage of dynamic control signaling (as opposed to RRC): iv. For inter-cell beam management, a UE can transmit to or receive from only a single cell (i.e. serving cell does not change when beam selection is done). This includes L1-only measurement/reporting (i.e. no L3 impact) and beam indication associated with cell(s) with any Physical Cell ID(s): The beam indication is based on Rel-17 unified TCI framework; The same beam measurement/reporting mechanism will be reused for inter-cell mTRP; This work shall only consider intra-Distributed Unit (intra-DU) and intra-frequency cases.

As mentioned above, there are enhancements on multi-beam operation, mainly targeting FR2 while also applicable to FRI: a. Identify and specify features to facilitate more efficient (lower latency and overhead) DL/UL beam management to support higher intra- and L1/L2-centric inter-cell mobility and/or a larger number of configured TCI states: i. Common beam for data and control transmission/reception for DL and UL, especially for intra-band CA: ii. Unified TCI framework for DL and UL beam indication; iii. Enhancement on signaling mechanisms for the above features to improve latency and efficiency with more usage of dynamic control signaling (as opposed to RRC).

It is proposed to support L1-based beam indication using at least UE-specific (unicast) DCI to indicate joint or separate DL/UL beam indication from the active TCI states. The existing DCI formats 1_1 and 1_2 are reused for beam indication and it supports a mechanism for UE to acknowledge successful decoding of beam indication. The ACK/NACK of the PDSCH scheduled by the DCI carrying the beam indication can be used as an ACK also for the DCI.

It is also proposed to support activation of one or more TCI states via medium access control (MAC) control element (CE) analogous to Release. 15/16. At least for the single activated TCI state, the activated TCI state is applied.

For beam indication with Rel-17 unified TCI, support DCI format 1_1/1_2 without DL assignment, acknowledgement/negative acknowledgement (ACK/NACK) mechanism is used analogously to that for semi-persistent scheduling (SPS) PDSCH release with both type-1 and type-2 HARQ-ACK codebook. Upon a successful reception of the beam indication DCI, the UE reports an ACK.

For type-1 HARQ-ACK codebook, a location for the ACK information in the HARQ-ACK codebook is determined based on a virtual PDSCH indicated by the time domain resource allocation (TDRA) field in the beam indication DCI, based on the time domain allocation list configured for PDSCH. For type-2 HARQ-ACK codebook, a location for the ACK information in the HARQ-ACK codebook is determined according to the same rule for SPS release. The ACK is reported in a PUCCH k slots after the end of the PDCCH reception where k is indicated by the PDSCH-to-HARQ_feedback timing indicator field in the DCI format, or provided dl-DataToUL-ACK or dl-DataToUL-ACK-ForDCI-Format1-2-r16 if the PDSCH-to-HARQ_feedback timing indicator field is not present in the DCI.

When used for beam indication, configured scheduling-radio network temporary identifier (CS-RNTI) is used to scramble the CRC for the DCI. The values of the following DCI fields are set as follows: RV=all ‘1’s: MCS=all ‘1’s: NDI=0; and set to all ‘0’s for FDRA Type 0, or all ‘1’s for FDRA Type 1, or all ‘0’s for dynamicSwitch (same as in Table 10.2-4 of TS38.213).

The TCI field can be used to signal the following: 1) Joint DL/UL TCI state, 2) DL-only TCI state (for separate DL/UL TCI), 3) UL-only TCI state (for separate DL/UL TCI).

In addition, the following DCI fields are being used in Rel-16: identifier for DCI formats: carrier indicator: bandwidth part indicator: time domain resource assignment (TDRA): downlink assignment index (if configured): transmit power control (TPC) command for scheduled PUCCH: PUCCH resource indicator: PDSCH-to-HARQ_feedback timing indicator (if present). The remaining unused DCI fields and codepoints are reserved in Release 17.

It is also proposed to support UE to report whether or not to support TCI update by DCI format 1_1/1_2. For a UE supporting TCI update by DCI format 1_1/1_2, it must support TCI update by using DCI 1_1/1_2 with DL assignment, and support of the above feature for TCI update by DCI format 1_1/1_2 without DL assignment is UE optional.

On Rel-17 DCI-based beam indication, regarding application time of the beam indication, the first slot or the first subslot that is at least X ms or Y symbols after the last symbol of the acknowledgment of the joint or separate DL/UL beam indication.

In some embodiments, a slot comprises 14 or 12 Orthogonal Frequency Divided Multiplexing (OFDM) symbols. In some embodiments, a subslot comprises at least one of {2, 4, 7} OFDM symbols.

According to TS 38.212 section 7.3.1.2.2 Format 1_1, Transmission configuration indication-0 bit if higher layer parameter tci-PresentInDCI is not enabled: otherwise 3 bits as defined in Clause 5.1.5 of [6, TS38.214]. According to TS 38.212 section 7.3.1.2.3 Format 1_2, Transmission configuration indication-0 bit if higher layer parameter tci-PresentDCI-1-2 is not configured: otherwise 1 or 2 or 3 bits determined by higher layer parameter tci-PresentDCI-1-2 as defined in Clause 5.1.5 of [6, TS38.214].

The UE receives an activation command, as described in clause 6.1.3.14 of [10, TS 38.321], used to map up to 8 TCI states to the codepoints of the DCI field ‘Transmission Configuration Indication’ in one Component Carrier (CC)/DL Bandwidth Part (BWP) or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, as described in clause 6.1.3.24 of [10, TS 38.321], the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2. For example, if the number of bits for the DCI field ‘Transmission Configuration Indication’ of DCI format 1_2 or the number of bits of higher layer parameter tci-PresentDCI-1-2 is 1 bit, then S=2. For another example, if the number of bits for the DCI field ‘Transmission Configuration Indication’ of DCI format 1_2 or the number of bits of higher layer parameter tci-PresentDCI-1-2 is 2 bits, then S=4. For another example, if the number of bits for the DCI field ‘Transmission Configuration Indication’ of DCI format 1_2 or the number of bits of higher layer parameter tci-PresentDCI-1-2 is 3 bits, then S=8.

Moreover, DCI format 1_1/1_2 with and without DL assignment can be used for dynamic beam indication. If beam indication is indicated by DCI format with DL scheduling, ACK/NACK of PDSCH can be used to indicate ACK of the beam indication, and after a timing, indicated beam can be applied.

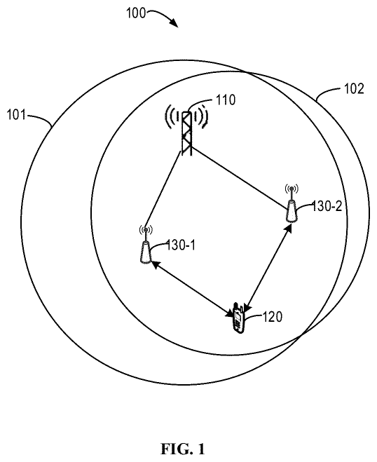

FIG. 1 shows an example communication network 100 in which embodiments of the present disclosure can be implemented. The network 100 includes a network device 110 and a terminal device 120 served by the network device 110. The network 100 may provide one or more serving cells to serve the terminal device 120.

The communication network 100 further comprises a network device 110. In the communication network 100, the network device 110 and the terminal devices 120 can communicate data and control information to each other. The numbers of devices shown in FIG. 1 are given for the purpose of illustration without suggesting any limitations.

In some scenarios, carrier aggregation (CA) can be supported in the network 100, in which two or more CCs are aggregated in order to support a broader bandwidth. For example, in FIG. 1, the network device 110 may provide to the terminal device 120 a plurality of serving cells including one primary cell (Pcell) 101 corresponding to a primary CC and at least one secondary cell (Scell) 102 corresponding to at least one secondary CC.

It is to be understood that the number of network devices, terminal devices and/or serving cells is only for the purpose of illustration without suggesting any limitations to the present disclosure. The network 100 may include any suitable number of network devices, terminal devices and/or serving cells adapted for implementing implementations of the present disclosure.

In some other scenarios, the terminal device 120 may establish connections with two different network devices (not shown in FIG. 1) and thus can utilize radio resources of the two network devices. The two network devices may be respectively defined as a master network device and a secondary network device. The master network device may provide a group of serving cells, which are also referred to as “Master Cell Group (MCG)”. The secondary network device may also provide a group of serving cells, which are also referred to as “Secondary Cell Group (SCG)”. For Dual Connectivity operation, a term “Special Cell (Spcell)” may refer to the Pcell of the MCG or the primary Scell (Pscell) of the SCG depending on if the terminal device 120 is associated to the MCG or the SCG, respectively. In other cases than the Dual Connectivity operation, the term “SpCell” may also refer to the PCell.

In one embodiment, the terminal device 120 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 120 from at least one of the first network device and the second network device. In one embodiment, first information may be transmitted to the terminal device 120 from the first network device and second information may be transmitted to the terminal device 120 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

In the communication network 100 as shown in FIG. 1, the network device 110 can communicate data and control information to the terminal device 120 and the terminal device 120 can also communication data and control information to the network device 110. A link from the network device 110 to the terminal device 120 is referred to as a downlink (DL), while a link from the terminal device 120 to the network device 110 is referred to as an uplink (UL).

In some embodiments, for downlink transmissions, the network device 110 may transmit control information via a PDCCH and/or transmit data via a PDSCH to the terminal device 120. Additionally, the network device 110 may transmit one or more reference signals (RSs) to the terminal device 120. The RS transmitted from the network device 110 to the terminal device 120 may also referred to as a “DL RS”. Examples of the DL RS may include but are not limited to Demodulation Reference Signal (DM-RS), Channel State Information-Reference Signal (CSI-RS), Sounding Reference Signal (SRS), Phase Tracking Reference Signal (PTRS), fine time and frequency Tracking Reference Signal (TRS) and so on.

In some embodiments, for uplink transmissions, the terminal device 120 may transmit control information via a PUCCH and/or transmit data via a PUSCH to the network device 110. Additionally, the terminal device 120 may transmit one or more RSs to the network device 110. The RS transmitted from the terminal device 120 to the network device 110 may also referred to as a “UL RS”. Examples of the UL RS may include but are not limited to DM-RS, CSI-RS, SRS, PTRS, fine time and frequency TRS and so on.

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, wireless local network communication protocols such as Institute for Electrical and Electronics Engineers (IEEE) 802.11 and the like. Moreover, the communication may utilize any proper wireless communication technology; comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

The network device 110 (such as, a gNB) may be equipped with one or more TRPs or antenna panels. As used herein, the term “TRP” refers to an antenna array (with one or more antenna elements) available to the network device located at a specific geographical location. For example, a network device may be coupled with multiple TRPs in different geographical locations to achieve better coverage. The one or more TRPs may be included in a same serving cell or different serving cells.

It is to be understood that the TRP can also be a panel, and the panel can also refer to an antenna array (with one or more antenna elements). Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below:

As shown in FIG. 1, for example, the network device 110 may communicate with the terminal device 120 via TRPs 130-1 and 130-2 (collectively referred to as “TRPs 130” or individually referred to as “TRP 130” in the following). For example, the TRP 130-1 may be also referred to as the first TRP, while the TRP 130-2 may be also referred to as the second TRP. As described above, the network device 110 may provide a group of cells to serve the terminal device 120. In some embodiments, the group of cells may be divided into a first subset of cells associated with the first TRP 130-1 and a second subset of cells associated with the second TRP 130-2. For example, the first subset of cells and the second subset of cells may include one or more overlapping cells or may not overlap each other.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHZ, an extending NR operation up to 71 GHZ, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity:

It is to be understood that the numbers of network devices, terminal devices and/or TRPs are only for the purpose of illustration without suggesting any limitations to the present disclosure. The communication network 100 may include any suitable number of network devices, terminal devices and/or TRPs adapted for implementing implementations of the present disclosure.

In some embodiments, the TRPs may be explicitly associated with different higher-layer configured identities. For example, a higher-layer configured identity can be associated with a Control Resource Set (CORESET), a group of CORESETs, a reference signal (RS), a set of RS, a Transmission Configuration Indication (TCI) state or a group of TCI states, which is used to differentiate between transmissions between different TRPs and the terminal device 120. When the terminal device 120 receives two DCIs from two CORESETs which are associated with different higher-layer configured identities, the two DCIs may be transmitted or indicated from different TRPs. Further, the TRPs may be implicitly identified by a dedicated configuration to the physical channels or signals. For example, a dedicated CORESET, a RS, and a TCI state, which are associated with a TRP, are used to identify a transmission from a different TRP to the terminal device 120. For example, when the terminal device 120 receives a DCI from a dedicated CORESET, the DCI is indicated from the associated TRP dedicated by the CORESET. In some embodiments, the RS may be at least one of CSI-RS, SRS, positioning RS, uplink DM-RS, downlink DM-RS, uplink PTRS and downlink PTRS.

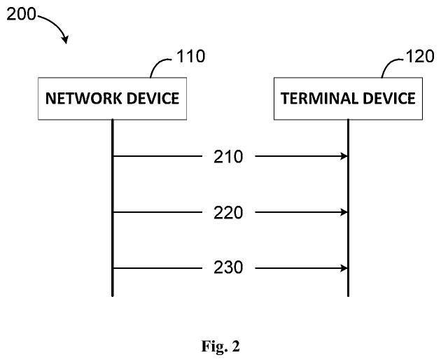

FIG. 2 illustrates a signaling chart for communication between network device and terminal device in accordance with some embodiments of the present disclosure. For the purpose of discussion, the process 200 will be described with reference to FIG. 1. The process 200 may involve the network device 110 and the terminal device 120 as shown in FIG. 1.

In some embodiments, for example, as shown in FIG. 2, the network device 110 may configure/transmit one or more configurations 210 to the terminal device 120. In some embodiments, for example, as shown in FIG. 2, the terminal device 120 may receive one or more configurations 210 from the network device 110. In some embodiments, the one or more configurations 210 may include at least one of configuration/indication/activation of TCI state(s), configuration of physical cell identities (IDs), configuration of CORESET, configuration of search space, configuration of PDCCH, configuration of PDSCH, configuration of PUSCH, configuration of PUCCH, configuration of control information for data transmission/reception, configuration of reference signal (RS) transmission/reception, configuration of repetition/transmission/reception scheme. In some embodiments, the network device 110 may transmit a first PDCCH (e.g. 220 as shown in FIG. 2) to the terminal device 120. In some embodiments, the terminal device 120 may receive the first PDCCH (e.g. 220 as shown in FIG. 2) from the network device 110. In some embodiments, the network device 110 may transmit a second PDCCH (e.g. 230 as shown in FIG. 2) to the terminal device 120 based on a condition. In some embodiments, the terminal device 120 may receive the second PDCCH (e.g. 230 as shown in FIG. 2) from the network device 110 based on the condition. In some embodiments, there may be only a subset of signaling in process 200. For example, there may be only 210 and 220 in process 200. For another example, there may be only 210 and 230 in process 200.

In the following, the terms “transmission occasions”, “reception occasions”, “repetitions”, “transmission”, “reception”, “PDSCH transmission occasions”, “PDSCH repetitions”, “PUSCH transmission occasions”, “PUSCH repetitions”, “PUCCH occasions”, “PUCCH repetitions”, “repeated transmissions”, “repeated receptions”, “PDSCH transmissions”, “PDSCH receptions”, “PUSCH transmissions”, “PUSCH receptions”, “PUCCH transmissions”, “PUCCH receptions”, “RS transmission”, “RS reception”, “communication”, “scheduling”, “transmissions” and “receptions” can be used interchangeably: The terms “TCI state”, “set of QCL parameter(s)”, “QCL parameter(s)”, “QCL assumption” and “QCL configuration” can be used interchangeably. The terms “TCI field”, “TCI state field”, and “transmission configuration indication” can be used interchangeably: The terms “transmission occasion”, “transmission”, “repetition”, “reception”, “reception occasion”, “monitoring occasion”, “PDCCH monitoring occasion”, “PDCCH transmission occasion”, “PDCCH transmission”, “PDCCH candidate”, “PDCCH reception occasion”, “PDCCH reception”, “search space”, “CORESET”, “multi-chance” and “PDCCH repetition” can be used interchangeably. In the following, the terms “PDCCH repetitions”, “repeated PDCCHs”, “repeated PDCCH signals”, “PDCCH candidates configured for same scheduling”, “PDCCH”, “PDCCH candidates” and “linked PDCCH candidates” can be used interchangeably. The terms “DCI” and “DCI format” can be used interchangeably. In some embodiments, the embodiments in this disclosure can be applied to PDSCH and PUSCH scheduling, and in the following, PDSCH scheduling is described as examples. For example, the embodiments in this disclosure can be applied to PUSCH by replacing “transmit” to “receive” and/or “receive” to “transmit”. The terms “PDSCH” and “PUSCH” can be used interchangeably. The terms “transmit” and “receive” can be used interchangeably.

As specified in the 3GPP specifications (TS 38.214), a UE can be configured with a list of up to M TCI-State configurations within the higher layer parameter PDSCH-Config to decode PDSCH according to a detected PDCCH with DCI intended for the UE and the given serving cell, where M depends on the UE capability max NumberConfiguredTCIstatesPerCC. Each TCI-State contains parameters for configuring a quasi co-location relationship between one or two downlink reference signals and the DM-RS ports of the PDSCH, the DM-RS port of PDCCH or the channel state information reference signal (CSI-RS) port(s) of a CSI-RS resource. The quasi co-location relationship is configured by the higher layer parameter qcl-Type1 for the first downlink (DL) RS, and qcl-Type2 for the second DL RS (if configured). For the case of two DL RSS, the QCL types shall not be the same, regardless of whether the references are to the same DL RS or different DL RSs. The quasi co-location types corresponding to each DL RS are given by the higher layer parameter qcl-Type in QCL-Info and may take one of the following values:

‘QCL-TypeA’: {Doppler shift, Doppler spread, average delay, delay
spread}
‘QCL-TypeB’: {Doppler shift, Doppler spread}
‘QCL-TypeC’: {Doppler shift, average delay}
‘QCL-TypeD’: {Spatial Rx parameter}

The UE receives an activation command, as described in clause “TCI States Activation/Deactivation for UE-specific PDSCH MAC CE” (for example, clause 6.1.3.14) of [TS 38.321] or in clause “Enhanced TCI States Activation/Deactivation for UE-specific PDSCH MAC CE” (for example, clause 6.1.3) of [TS 38.321], used to map up to 8 TCI states to the codepoints of the DCI field ‘Transmission Configuration Indication’ in one CC/DL BWP or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, as described in clause “TCI States Activation/Deactivation for UE-specific PDSCH MAC CE” or clause “Enhanced TCI States Activation/Deactivation for UE-specific PDSCH MAC CE” (for example, clause 6.1.3.14 or subclause under 6.1.3) of [TS 38.321], the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot or the first subslot that is after slot n+3Nₛₗₒₜ^{subframe,μ} V slot where μ is the SCS configuration for the PUCCH. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the synchronization signal/physical broadcast channel (SS/PBCH) block determined in the initial access procedure with respect to qcl-Type set to ‘typeA’, and when applicable, also with respect to qcl-Type set to ‘typeD’.

In some embodiments, if a UE is configured with the higher layer parameter tci-PresentInDCI that is set as ‘enabled’ or tci-PresentInDCI-ForFormat1_2 is configured for the CORESET scheduling the PDSCH, the UE assumes that the TCI field is present in the DCI (for example DCI format 1_1 or DCI format 1_2) of the PDCCH transmitted on the CORESET. If tci-PresentInDCI or tci-PresentInDCI-ForFormat1_2 is not configured for the CORESET scheduling the PDSCH or the PDSCH is scheduled by a DCI (for example, DCI format 1_0), the UE assumes that the TCI field is not present in the DCI (for example DCI format 1_1 or DCI format 1_2 or DCI format 1_0) of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability [13, TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If tci-PresentInDCI is set to “enabled” or tci-PresentInDCI-ForFormat1_2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to ‘QCL-TypeA’, and when applicable, also with respect to ‘QCL-TypeD’. The value of timeDurationForQCL is based on reported UE capability.

If a UE is configured with the higher layer parameter tci-PresentInDCI that is set as ‘enabled’ for the CORESET scheduling the PDSCH, the UE assumes that the TCI field is present in the DCI (for example, DCI format 1_1) of the PDCCH transmitted on the CORESET. If a UE is configured with the higher layer parameter tci-PresentInDCI-ForFormat1_2 for the CORESET scheduling the PDSCH, the UE assumes that the TCI field with a DCI field size indicated by tci-PresentInDCI-ForFormat1_2 is present in the DCI (for example, DCI format 1_2) of the PDCCH transmitted on the CORESET. If the PDSCH is scheduled by a DCI format not having the TCI field present, and the time offset between the reception of the DL DCI and the corresponding PDSCH is equal to or greater than a threshold timeDurationForQCL if applicable, where the threshold is based on reported UE capability [TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If the PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability [TS 38.306]. When the UE is configured with a single slot PDSCH, the indicated TCI state should be based on the activated TCI states in the slot with the scheduled PDSCH. When the UE is configured with a multi-slot PDSCH, the indicated TCI state should be based on the activated TCI states in the first slot or the subslot with the scheduled PDSCH, and UE shall expect the activated TCI states are the same across the slots with the scheduled PDSCH. When the UE is configured with CORESET associated with a search space set for cross-carrier scheduling, and the PDCCH carrying the scheduling DCI and the PDSCH scheduled by that DCI are transmitted on the same carrier, the UE expects tci-PresentInDCI is set as ‘enabled’ or tci-PresentInDCI-ForFormat1_2 is configured for the CORESET, and if one or more of the TCI states configured for the serving cell scheduled by the search space set contains ‘QCL-TypeD’, the UE expects the time offset between the reception of the detected PDCCH in the search space set and the corresponding PDSCH is larger than or equal to the threshold timeDurationForQCL.

Independent of the configuration of tci-PresentInDCI and tci-PresentInDCI-ForFormat1_2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’.
the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).
If a UE is configured with enableDefaultTCIStatePerCoresetPoolIndex and the UE is configured by higher layer parameter PDCCH-Config that contains two different values of coresetPoolIndex in different ControlResourceSets.
the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same coresetPoolIndex, the UE is expected to prioritize the reception of PDCCH associated with that CORESET. This also applies to the intra-band CA case (when PDSCH and the CORESET are in different component carriers).
If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers)
In all cases above, if none of configured TCI states for the serving cell of scheduled PDSCH is configured with qcl-Type set to ‘typeD’, the UE shall obtain the other QCL assumptions from the indicated TCI states for its scheduled PDSCH irrespective of the time offset between the reception of the DL DCI and the corresponding PDSCH.

If the PDCCH carrying the scheduling DCI is received on one component carrier, and the PDSCH scheduled by that DCI is on another component carrier and the UE is configured with enable Default Beam-ForCCS:
The timeDurationForQCL is determined based on the subcarrier spacing of the scheduled PDSCH. If μ_{PDCCH}<μ_{PDSCH} an additional timing delay

$$d \frac{{2}^{μ} PDSCH}{{2}^{μ} PDCCH}$$

is added to the timeDurationForQCL, where d is defined in 5.2.1.5.1a-1, otherwise dis zero:
For both the cases, when the offset between the reception of the DL DCI and the corresponding PDSCH is less than the threshold timeDurationForQCL, and when the DL DCI does not have the TCI field present, the UE obtains its QCL assumption for the scheduled PDSCH from the activated TCI state with the lowest ID applicable to PDSCH in the active BWP of the scheduled cell.

For a periodic CSI-RS resource in an NZP-CSI-RS-ResourceSet configured with higher layer parameter trs-Info, the UE shall expect that a TCI-State indicates one of the following quasi co-location type(s):
‘typeC’ with an SS/PBCH block and, when applicable, ‘typeD’ with the same SS/PBCH block, or
‘typeC’ with an SS/PBCH block and, when applicable, ‘typeD’ with a CSI-RS resource in an NZP-CSI-RS-ResourceSet configured with higher layer parameter repetition, or

For an aperiodic CSI-RS resource in an NZP-CSI-RS-ResourceSet configured with higher layer parameter trs-Info, the UE shall expect that a TOI-State indicates qcl-Type set to ‘typeA’ with a periodic CSI-RS resource in a NZP-CSI-RS-ResourceSet configured with higher layer parameter trs-Info and, when applicable, qcl-Type set to ‘typeD’ with the same periodic CSI-RS resource.

For a CSI-RS resource in an NZP-CSI-RS-ResourceSet configured without higher layer parameter trs-Info and without the higher layer parameter repetition, the UE shall expect that a TOI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with an SS/PBCH block, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeB’ with a CSI-RS resource in a NZP-CSI-RS-ResourceSet configured with higher layer parameter trs-Info when ‘typeD’ is not applicable.

For a CSI-RS resource in an NZP-CSI-RS-ResourceSet configured with higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeC’ with an SS/PBCH block and, when applicable, ‘typeD’ with the same SS/PBCH block.

For the DM-RS of PDCCH, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

For the DM-RS of PDSCH, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
typeA′ with a CSI-RS resource in a NZP-CSI-RS-ResourceSet configured without higher layer parameter trs-Info and without higher layer parameter repetition and, when applicable, ‘typeD’ with the same CSI-RS resource.

If the PDCCH carrying the scheduling DCI is received on one component carrier, and the PDSCH scheduled by that DCI is on another component carrier: The timeDurationForQCL is determined based on the subcarrier spacing of the scheduled PDSCH. If μ_{PDCCH}<μ_{PDSCH} an additional timing delay d is added to the timeDurationForQCL, where d is defined as 8 symbols if subcarrier spacing for the PDCCH is 15 kHz. or 8 symbols if subcarrier spacing for the PDCCH is 30 KHz. or 14 symbols if subcarrier spacing for the PDCCH is 60 KHz. For example, the symbol is PDCCH symbol, or the symbol is based on the subcarrier spacing of PDCCH (for example, as defined in Table 5.2.1.5.1a-1 of TS 38.214); For both the cases when tci-PresentInDCI is set to ‘enabled’ and the offset between the reception of the DL DCI and the corresponding PDSCH is less than the threshold timeDurationForQCL and when tci-PresentInDCI is not configured, the UE obtains its QCL assumption for the scheduled PDSCH from the activated TCI state with the lowest ID applicable to PDSCH in the active BWP of the scheduled cell.

As specified in the 3GPP specifications (TS 38.214), when a UE is configured by higher layer parameter RepSchemeEnabler set to one of ‘FDMSchemeA’, ‘FDMSchemeB’, ‘TDMSchemeA’, if the UE is indicated with two TCI states in a codepoint of the DCI field ‘Transmission Configuration Indication’ and DM-RS port(s) within one CDM (Code Domain Multiplexing) group in the DCI field “Antenna Port(s)”. When two TCI states are indicated in a DCI and the UE is set to ‘FDMSchemeA’, the UE shall receive a single PDSCH transmission occasion of the TB with each TCI state associated to a non-overlapping frequency domain resource allocation as described in clause “Physical resource block (PRB) bundling” (for example Clause 5.1.2.3) in TS 38.214. When two TCI states are indicated in a DCI and the UE is set to ‘FDMSchemeB’, the UE shall receive two PDSCH transmission occasions of the same TB with each TCI state associated to a PDSCH transmission occasion which has non-overlapping frequency domain resource allocation with respect to the other PDSCH transmission occasion as described in clause “Physical resource block (PRB) bundling” (for example Clause 5.1.2.3) in TS 38.214. When two TCI states are indicated in a DCI and the UE is set to ‘TDMSchemeA’, the UE shall receive two PDSCH transmission occasions of the same TB with each TCI state associated to a PDSCH transmission occasion which has non-overlapping time domain resource allocation with respect to the other PDSCH transmission occasion and both PDSCH transmission occasions shall be received within a given slot as described in Clause “Resource allocation in time domain” (for example, clause 5.1.2.1) in TS 38.214.

When a UE is configured by the higher layer parameter PDSCH-config that indicates at least one entry in pdsch-TimeDomainAllocationList containing RepNumR16 in PDSCH-TimeDomainResourceAllocation, the UE may expect to be indicated with one or two TCI states in a codepoint of the DCI field ‘Transmission Configuration Indication’ together with the DCI field “Time domain resource assignment indicating an entry in pdsch-TimeDomainAllocationList which contain RepNum16 in PDSCH-TimeDomainResourceAllocation and DM-RS port(s) within one CDM group in the DCI field “Antenna Port(s)”. When two TCI states are indicated in a DCI with Transmission Configuration Indication’ field, the UE may expect to receive multiple slot level PDSCH transmission occasions of the same TB with two TCI states used across multiple PDSCH transmission occasions as defined in Clause “Resource allocation in time domain” (for example, clause 5.1.2.1) in TS 38.214. When one TCI state is indicated in a DCI with Transmission Configuration Indication field, the UE may expect to receive multiple slot level PDSCH transmission occasions of the same TB with one TCI state used across multiple PDSCH transmission occasions as defined in Clause “Resource allocation in time domain” (for example, clause 5.1.2.1) in TS 38.214.

When a UE is not indicated with a DCI that DCI field “Time domain resource assignment’ indicating an entry in pdsch-TimeDomainAllocationList which contain RepNumR16 in PDSCH-TimeDomainResourceAllocation, and it is indicated with two TCI states in a codepoint of the DCI field ‘Transmission Configuration Indication’ and DM-RS port(s) within two CDM groups in the DCI field “Antenna Port(s)”, the UE may expect to receive a single PDSCH where the association between the DM-RS ports and the TCI states are as defined in Clause “DM-RS reception procedure” (for example, clause 5.1.6.2) in TS 38.214.

When a UE is not indicated with a DCI that DCI field “Time domain resource assignment’ indicating an entry in pdsch-TimeDomainAllocationList which contain RepNumR16 in PDSCH-TimeDomainResourceAllocation, and it is indicated with one TCI states in a codepoint of the DCI field ‘Transmission Configuration Indication’, the UE procedure for receiving the PDSCH upon detection of a PDCCH follows Clause “UE procedure for receiving the physical downlink shared channel” (for example, Clause 5.1) in TS 38.214.

In the following, the terms “FDMSchemeA” and “Scheme 2a” can be used interchangeably: The terms “FDMSchemeB” and “Scheme 2b” can be used interchangeably. The terms “TDMSchemeA” and “Scheme 3” can be used interchangeably. The terms “RepNumR16” and “Scheme 4” can be used interchangeably.

As specified in the 3GPP specifications (TS 38.214), when a UE is configured by the higher layer parameter RepSchemeEnabler set to ‘TDMSchemeA’ and indicated DM-RS port(s) within one CDM group in the DCI field “Antenna Port(s)”, the number of PDSCH transmission occasions is derived by the number of TCI states indicated by the DCI field ‘Transmission Configuration Indication’ of the scheduling DCI. If two TCI states are indicated by the DCI field “Transmission Configuration Indication’, the UE is expected to receive two PDSCH transmission occasions, where the first TCI state is applied to the first PDSCH transmission occasion and resource allocation in time domain for the first PDSCH transmission occasion follows Clause “Resource allocation in time domain” (for example, clause 5.1.2.1) in TS 38.214. The second TCI state is applied to the second PDSCH transmission occasion, and the second PDSCH transmission occasion shall have the same number of symbols as the first PDSCH transmission occasion. If the UE is configured by the higher layers with a value K in StartingSymbolOffsetK, it shall determine that the first symbol of the second PDSCH transmission occasion starts after K symbols from the last symbol of the first PDSCH transmission occasion. If the value K is not configured via the higher layer parameter StartingSymbolOffsetK, K=0) shall be assumed by the UE. The UE is not expected to receive more than two PDSCH transmission layers for each PDSCH transmission occasion. For two PDSCH transmission occasions, the redundancy version to be applied is derived according to Table 5.1.2.1-2 in TS 38.214, where n=0, 1 applied respectively to the first and second TCI state. Otherwise, the UE is expected to receive a single PDSCH transmission occasion, and the resource allocation in the time domain follows Clause “Resource allocation in time domain” (for example, clause 5.1.2.1) in TS 38.214.

As specified in the 3GPP specifications (TS 38.214), when a UE configured by the higher layer parameter PDSCH-config that indicates at least one entry in pdsch-TimeDomainAllocationList contain RepNumR16 in PDSCH-TimeDomainResourceAllocation. If two TCI states are indicated by the DCI field “Transmission Configuration Indication together with the DCI field “Time domain resource assignment’ indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV (Start and length indicator value) is applied for all PDSCH transmission occasions, the first TCI state is applied to the first PDSCH transmission occasion and resource allocation in time domain for the first PDSCH transmission occasion follows Clause “Resource allocation in time domain” (for example, clause 5.1.2.1) in TS 38.214. When the value indicated by RepNumR16 in PDSCH-TimeDomainResourceAllocation equals to two, the second TCI state is applied to the second PDSCH transmission occasion. When the value indicated by RepNumR16 in PDSCH-TimeDomainResourceAllocation is larger than two, the UE may be further configured to enable CycMapping or SeqMapping in RepTCIMapping. When CycMapping is enabled, the first and second TCI states are applied to the first and second PDSCH transmission occasions, respectively, and the same TCI mapping pattern continues to the remaining PDSCH transmission occasions. When SeqMapping is enabled, first TCI state is applied to the first and second PDSCH transmissions, and the second TCI state is applied to the third and fourth PDSCH transmissions, and the same TCI mapping pattern continues to the remaining PDSCH transmission occasions. The UE may expect that each PDSCH transmission occasion is limited to two transmission layers. For all PDSCH transmission occasions associated with the first TCI state, the redundancy version to be applied is derived according to Table 5.1.2.1-2 [TS 38.214], where n is counted only considering PDSCH transmission occasions associated with the first TCI state. The redundancy version for PDSCH transmission occasions associated with the second TCI state is derived according to Table 5.1.2.1-3 [TS 38.214], where additional shifting operation for each redundancy version rvs is configured by higher layer parameter RVSeqOffset and n is counted only considering PDSCH transmission occasions associated with the second TCI state. If one TCI state is indicated by the DCI field ‘Transmission Configuration Indication’ together with the DCI field “Time domain resource assignment indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV is applied for all PDSCH transmission occasions, the first PDSCH transmission occasion follows Clause “Resource allocation in time domain” (for example, clause 5.1.2.1) in TS 38.214, the same TCI state is applied to all PDSCH transmission occasions. The UE may expect that each PDSCH transmission occasion is limited to two transmission layers. For all PDSCH transmission occasions, the redundancy version to be applied is derived according to Table 5.1.2.1-2 [TS 38.214], where n is counted considering PDSCH transmission occasions. Otherwise, the UE is expected to receive a single PDSCH transmission occasion, and the resource allocation in the time domain follows Clause “Resource allocation in time domain” (for example, clause 5.1.2.1) in TS 38.214.

TABLE 5.1.2.1-2
Applied redundancy version when pdsch-AggregationFactor
is present

| rv_{id} indicated | | | | |
|---|---|---|---|---|
| by the DCI | | | | |
| scheduling | rv_{id} to be applied to n^{th} transmission occasion | | | |
| the PDSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 5
1.2.1-3: Applied redundancy version for the second TCI state
when RVSeqOffset is present

| rv_{id} indicated | | | | |
|---|---|---|---|---|
| by the DCI | rv_{id} to be applied to n^{th} transmission occasion | | | |
| scheduling | with second TCI state | | | |
| the PDSCH | n mod 4 = 0 | n mod 4 = 1 | n mod 4 = 2 | n mod 4 = 3 |
| 0 | (0 + rvₛ) | (2 + rvₛ) | (3 + rvₛ) | (1 + rvₛ) |
| | mod 4 | mod 4 | mod 4 | mod 4 |
| 2 | (2 + rvₛ) | (3 + rvₛ) | (1 + rvₛ) | (0 + rvₛ) |
| | mod 4 | mod 4 | mod 4 | mod 4 |
| 3 | (3 + rvₛ) | (1 + rvₛ) | (0 + rvₛ) | (2 + rvₛ) |
| | mod 4 | mod 4 | mod 4 | mod 4 |
| 1 | (1 + rvₛ) | (0 + rvₛ) | (2 + rvₛ) | (3 + rvₛ) |
| | mod 4 | mod 4 | mod 4 | mod 4 |

As specified in the 3GPP specifications (TS 38.214), For a UE configured by the higher layer parameter RepSchemeEnabler set to “FDMSchemeA’ or ‘FDMSchemeB’, and when the UE is indicated with two TCI states in a codepoint of the DCI field ‘Transmission Configuration Indication and DM-RS port(s) within one CDM group in the DCI field “Antenna Port(s)”. If P_{BWP,i}′ is determined as “wideband”, the first

$$⌈ \frac{{n}_{P R B}}{2} ⌉$$

PRBs are assigned to the first TCI state and the remaining

$$⌊ \frac{{n}_{P R B}}{2} ⌋$$

PRBs are assigned to the second TCI state, where n_{PRB} is the total number of allocated PRBs for the UE. If P_{BWP,i}′ is determined as one of the values among {2, 4}, even PRGs within the allocated frequency domain resources are assigned to the first TCI state and odd PRGs within the allocated frequency domain resources are assigned to the second TCI state. The UE is not expected to receive more than two PDSCH transmission layers for each PDSCH transmission occasion. For a UE configured by the higher layer parameter RepSchemeEnabler set to ‘FDMSchemeB’, and when the UE is indicated with two TCI states in a codepoint of the DCI field ‘Transmission Configuration Indication and DM-RS port(s) within one CDM group in the DCI field “Antenna Port(s)”, each PDSCH transmission occasion shall follow the Clause “Physical downlink shared channel” (for example Clause 7.3.1) of [TS 38.211] with the mapping to resource elements determined by the assigned PRBs for corresponding TCI state of the PDSCH transmission occasion, and the UE shall only expect at most two code blocks per PDSCH transmission occasion when a single transmission layer is scheduled and a single code block per PDSCH transmission occasion when two transmission layers are scheduled. For two PDSCH transmission occasions, the redundancy version to be applied is derived according to Table 5.1.2.1-2 of [TS 38.214], where n=0, 1 are applied to the first and second TCI state, respectively.

As specified in the 3GPP specifications (TS 38.213), for a CORESET other than a CORESET with index 0,
if a UE has not been provided a configuration of TCI state(s) by tci-StatesPDCCH-ToAddList and tci-StatesPDCCH-ToReleaseList for the CORESET, or has been provided initial configuration of more than one TCI states for the CORESET by tci-StatesPDCCH-ToAddList and tci-StatesPDCCH-ToReleaseList but has not received a MAC CE activation command for one of the TCI states, the UE assumes that the DM-RS antenna port associated with PDCCH receptions is quasi co-located with the SS/PBCH block the UE identified during the initial access procedure;
if a UE has been provided a configuration of more than one TCI states by tci-StatesPDCCH-ToAddList and tci-StatesPDCCH-ToReleaseList for the CORESET as part of Reconfiguration with sync procedure but has not received a MAC CE activation command for one of the TCI states, the UE assumes that the DM-RS antenna port associated with PDCCH receptions is quasi co-located with the SS/PBCH block or the CSI-RS resource the UE identified during the random access procedure initiated by the Reconfiguration with sync procedure.

In some embodiments, for a CORESET with index 0, the UE assumes that a DM-RS antenna port for PDCCH receptions in the CORESET is quasi co-located with
the one or more DL RS configured by a TCI state, where the TCI state is indicated by a MAC CE activation command for the CORESET, if any, or
a SS/PBCH block the UE identified during a most recent random access procedure not initiated by a PDCCH order that triggers a contention-free random access procedure, if no MAC CE activation command indicating a TCI state for the CORESET is received after the most recent random access procedure.

In some embodiments, for a CORESET other than a CORESET with index 0, if a UE is provided a single TCI state for a CORESET, or if the UE receives a MAC CE activation command for one of the provided TCI states for a CORESET, the UE assumes that the DM-RS antenna port associated with PDCCH receptions in the CORESET is quasi co-located with the one or more DL RS configured by the TCI state. For a CORESET with index 0, the UE expects that a CSI-RS configured with qcl-Type set to ‘typeD’ in a TCI state indicated by a MAC CE activation command for the CORESET is provided by a SS/PBCH block, and if the UE receives a MAC CE activation command for one of the TCI states, the UE applies the activation command in the first slot that is after slot k+3Nₛₗₒₜ^{subframe,μ} where k is the slot where the UE would transmit a PUCCH with HARQ-ACK information for the PDSCH providing the activation command and u is the SCS configuration for the PUCCH. The active BWP is defined as the active BWP in the slot when the activation command is applied.

In some embodiments, if a UE is configured for single cell operation or for operation with carrier aggregation in a same frequency band, and monitors PDCCH candidates in overlapping PDCCH monitoring occasions in multiple CORESETs that have been configured with same or different qcl-Type set to ‘typeD’ properties on active DL BWP(s) of one or more cells, then the UE monitors PDCCHs only in a CORESET, and in any other CORESET from the multiple CORESETs that have been configured with qcl-Type set to same ‘typeD’ properties as the CORESET, on the active DL BWP of a cell from the one or more cells
the CORESET corresponds to the CSS set with the lowest index in the cell with the lowest index containing CSS, if any: otherwise, to the USS set with the lowest index in the cell with lowest index
the lowest USS set index is determined over all USS sets with at least one PDCCH candidate in overlapping PDCCH monitoring occasions
for the purpose of determining the CORESET, a SS/PBCH block is considered to have different QCL ‘typeD’ properties than a CSI-RS
for the purpose of determining the CORESET, a first CSI-RS associated with a SS/PBCH block in a first cell and a second CSI-RS in a second cell that is also associated with the SS/PBCH block are assumed to have same QCL ‘typeD’ properties
the allocation of non-overlapping CCEs and of PDCCH candidates for PDCCH monitoring is according to all search space sets associated with the multiple CORESETs on the active DL BWP(s) of the one or more cells
the number of active TCI states is determined from the multiple CORESETs.

In some embodiments, if a UE is configured for single cell operation or for operation with carrier aggregation in a same frequency band, and monitors PDCCH candidates in overlapping PDCCH monitoring occasions in multiple CORESETs where none of the CORESETs has TCI-states configured with qcl-Type set to ‘typeD’, then the UE is required to monitor PDCCH candidates in overlapping PDCCH monitoring occasions for search space sets associated with different CORESETs.

In some embodiments, there is an application timing for beam indication or TCI state(s) indication. In some embodiments, the application timing may be the first slot or first subslot that is at least X ms or Y symbols after the last symbol of the acknowledge of the joint or separate DL/UL beam indication. For example, Y may be integer, and 1<=Y<=336. In some embodiments, slot may include 12 or 14 symbols. In some embodiments, subslot may include S symbols. S is integer, and 1<=S<=14. For example, S may be at least one of {2, 4, 7}. In some embodiments, the beam indication is indicated in a DCI in a PDCCH. For example, the DCI in the PDCCH may schedule a PDSCH or may not schedule a PDSCH. In some embodiments, the gap between the last symbol of the DCI and the first slot or the first subslot shall satisfy the capability for the terminal device. In some embodiments, the acknowledge of the joint or separate DL/UL beam indication may be the acknowledge of the PDSCH scheduled by the DCI. For example, when the DCI schedules the PDSCH. In some embodiments, the acknowledge of the joint or separate DL/UL beam indication may be the acknowledge of the DCI. For example, when the DCI doesn't schedule a PDSCH.

In some embodiments, the terminal device may receive or detect a DCI (for example, represented as “DCI_t”) in a PDCCH, and the DCI indicates a joint DL/UL TCI state or a separate DL/UL TCI state or a DL TCI state or a UL TCI state or a pair of DL/UL TCI states. In some embodiments, the second time threshold H2 may indicate a predetermined/configured time period after the first or last symbol of the PDCCH or the first or last symbol of the acknowledge of the indication. In some embodiments, the indicated joint DL/UL TCI state or separate DL/UL TCI state or DL TCI state or UL TCI state or the pair of DL/UL TCI states may be applied to PDSCH and/or CORESET and/or PUSCH and/or PUCCH and/or uplink RS and/or downlink RS after the application timing or the second time threshold H2. For example, when a joint DL/UL TCI state is indicated in the DCI, the joint DL/UL TCI state may be applied to PDSCH and/or CORESET and/or PUSCH and/or PUCCH and/or uplink RS and/or downlink RS after the application timing or the second time threshold H2. For another example, when a DL TCI state is indicated in the DCI, the DL TCI state may be applied to PDSCH and/or CORESET and/or downlink RS after the application timing or the second time threshold H2. For another example, when an UL TCI state is indicated in the DCI, the UL TCI state may be applied to PUSCH and/or PUCCH and/or uplink RS after the application timing or the second time threshold H2. For another example, when a pair of DL/UL TCI states are indicated in the DCI, the DL TCI state may be applied to PDSCH and/or CORESET and/or downlink RS after the application timing or the second time threshold H2, and the UL TCI state may be applied to PUSCH and/or PUCCH and/or uplink RS after the application timing or the second time threshold H2.

In some embodiments, the terminal device 120 may receive an indication to indicate a downlink TCI state (or a beam or a set of QCL parameters), and the source reference signal(s) in the TCI state provides QCL information at least for reception on PDSCH and all of CORESETs in a component carrier (CC). For example, the PDSCH is dedicated or UE-specific.

In some embodiments, the terminal device 120 may receive an indication to indicate an uplink TCI state (or a beam or a spatial relation), and the source reference signal(s) in the TCI state provides a reference for determining uplink transmission spatial filter at least for dynamic grant or configured grant based PUSCH, and all of PUCCH resources in a CC. For example, the PUCCH is dedicated or UE-specific.

In some embodiments, the terminal device 120 may receive an indication to indicate a joint TCI state (or a beam or a set of QCL parameters), and the TCI state refers to at least a common source reference signal used for determining both the downlink QCL information and the uplink transmission spatial filter.

In some embodiments, the terminal device 120 may receive an indication to indicate a downlink TCI state (or a beam or a set of QCL parameters) and an uplink TCI state (or a beam or a spatial relation), and the source reference signal(s) in the DL TCI state provides QCL information at least for reception on PDSCH and all of CORESETs in a component carrier (CC), and the source reference signal(s) in the TCI state provides a reference for determining uplink transmission spatial filter at least for dynamic grant or configured grant based PUSCH, and all of PUCCH resources in a CC. For example, the PUCCH is dedicated or UE-specific. For another example, the PDSCH is dedicated or UE-specific.

In some embodiments, the terminal device 120 may be configured with more than one (For example, represented as M, M is positive integer. For example, M may be 2 or 3 or 4) downlink TCI states, and/or the terminal device 120 may receive an indication to indicate one of the M TCI states, and the source reference signal(s) in the one of the M TCI states or in the indicated one TCI state provides QCL information at least for reception on PDSCH and/or a subset of CORESETs in a CC. For example, the PDSCH is dedicated or UE-specific.

In some embodiments, the terminal device 120 may be configured with more than one (For example, represented as N, N is positive integer. For example, N may be 2 or 3 or 4) uplink TCI states, and/or the terminal device 120 may receive an indication to indicate one of the N TCI states, and the source reference signal(s) in the one of the N TCI states or in the indicated one TCI state provides a reference for determining uplink transmission spatial filter at least for dynamic grant or configured grant based PUSCH, and/or a subset of PUCCH resources in a CC. For example, the PUCCH is dedicated or UE-specific.

In some embodiments, the terminal device 120 may be configured with more than one (For example, represented as M, M is positive integer. For example, M may be 2 or 3 or 4) joint DL/UL TCI states, and/or receive an indication to indicate one from the M joint TCI states, and each one of the M TCI states or the indicated one TCI state refers to at least a common source reference signal used for determining both the downlink QCL information and the uplink transmission spatial filter.

In some embodiments, the terminal device 120 may be configured with more than one (For example, represented as M, M is positive integer. For example, M may be 2 or 3 or 4) downlink TCI states and the terminal device 120 may be configured with more than one (For example, represented as N, N is positive integer. For example, N may be 2 or 3 or 4) uplink TCI states, and/or the terminal device 120 may receive an indication to indicate one from the M downlink TCI states and one from the N uplink TCI states, and the source reference signal(s) in each one of the M DL TCI states or the indicated one DL TCI state provides QCL information at least for reception on PDSCH and/or a subset of CORESETs in a component carrier (CC), and the source reference signal(s) in each one of the N TCI states or in the indicated one UL TCI state provides a reference for determining uplink transmission spatial filter at least for dynamic grant or configured grant based PUSCH, and/or a subset of PUCCH resources in a CC. For example, the PUCCH is dedicated or UE-specific. For another example, the PDSCH is dedicated or UE-specific.

In the following, DCI_t may be used to describe the DCI for joint DL/UL TCI state indication or for separate DL/UL TCI state indication. In the following, the terms “DCI”, “PDCCH”, “DCI_t”, “DCI for joint DL/UL TCI state indication”, “DCI for separate DL/UL TCI state indication”, “DCI for DL TCI state indication”, “DCI for UL TCI state indication”, “PDCCH for joint DL/UL TCI state indication”, “PDCCH for separate DL/UL TCI state indication”, “PDCCH for DL TCI state indication”, “PDCCH for UL TCI state indication”, “DCI for TCI state indication” and “PDCCH for TCI state indication” can be used interchangeably.

In some embodiments, a DCI may be used for indicating a TCI state for joint DL/UL TCI state indication or for separate DL/UL TCI state indication. And the DCI may schedule a PDSCH (for example, DCI format 1_1 and format 1_2). In some embodiments, the HARQ of the PDSCH scheduled by the DCI can be used as an ACK for the DCI. For example, the DCI may be DCI_t.

In some embodiments, a DCI may be used for indicating a TCI state for joint DL/UL TCI state indication or for separate DL/UL TCI state indication. And the DCI may not schedule a PDSCH (for example, DCI format 1_1 and format 1_2). In some embodiments, a HARQ of the DCI may be introduced to indicate whether the DCI or the TCI state indication is successful. For example, the DCI may be DCI_t.

In some embodiments, if decoding of DCI_t or decoding of the PDSCH scheduled by DCI_t is ACK, the indicated TCI state may be applied for PDSCH and/or all or subset of CORESETs after an application timing.

In some embodiments, a DCI (for example, DCI_t) may be used for indicating one or more TCI states. For example, the one or more TCI states are for joint DL/UL TCI state indication or for separate DL/UL TCI state indication. And the DCI may not schedule a PDSCH (for example, DCI format 1_1 and format 1_2). In some embodiments, upon a successful reception/decoding of the DCI, the terminal device 120 may report an ACK. In some embodiments, upon a failed reception/decoding of the DCI, the terminal device 120) may report a NACK. For example, the ACK and/or NACK may be reported in a physical uplink control channel (PUCCH) or a physical uplink shared channel (PUSCH). In some embodiments, the terminal device 120 may be configured with a type of HARQ codebook. For example, the type may be at least one of Type 1 (for example, semi-static), Type 2 (for example, dynamic) and Type 3 (one shot feedback). For example, the type may be configured via at least one of RRC, MAC CE and DCI. In some embodiments, the DCI is received/detected in a PDCCH.

In some embodiments, the terminal device 120 may be configured/indicated with a first TCI state for reception of PDSCH and/or all or a subset of CORESETs. And the terminal device 120 may receive or detect a PDCCH with the first TCI state, and the PDCCH is in a first CORESET. In some embodiments, the terminal device 120 may be indicated with a second TCI state in the DCI received or detected in the first PDCCH. In some embodiments, the DCI in the PDCCH may schedule or may not schedule a first PDSCH or a first PUSCH. In some embodiments, the terminal device 120 may report the decoding result or HARQ-ACK information for at least one of the DCI or the PDCCH or the first PDSCH to the network device 110. For example, the decoding result or the HARQ-ACK information may be transmitted/reported in a PUCCH or in a second PUSCH. In some embodiments, after the application timing or after the second time threshold H2, the terminal device 120 may receive PDSCH and/or all or the subset of CORESETs with the second TCI state. For example, the terminal device 120 may receive another PDCCH with the second TCI state, and the another PDCCH is in a second CORESET. For another example, the terminal device 120 may receive another PDCCH with the second TCI state, and the another PDCCH is in the first CORESET.

In some embodiments, the terminal device 120 may receive an indication of a first TCI state, wherein the one or two RSs in the first TCI state may be associated with a first physical cell identity (ID). In some embodiments, the terminal device 120 may monitor or receive a first PDCCH in a first monitoring occasion for a first search space and/or associated scheduling or PDSCH scheduled by the first PDCCH based on a second TCI state or based on a quasi co-location (QCL) assumption, wherein the one or two RSs in the second TCI state and/or the QCL assumption may be associated with a second physical cell ID. In some embodiments, the terminal device 120 may monitor or receive a second PDCCH in a second monitoring occasion for a second search space and/or associated scheduling scheduled by the second PDCCH based on a condition.

In some embodiments, the scheduling may be at least one of: PDSCH, PUSCH, PUCCH, HARQ feedback, CSI-RS, SRS, downlink DM-RS, uplink DM-RS, downlink PTRS, uplink PTRS and TRS.

In some embodiments, there may be a first time duration, and the first time duration may be at least one of: a duration between a first timing/position and a second timing/position, a duration starting from the first timing/position to the second timing/position, a duration of a first number of symbols for the first PDCCH and a second number of symbols for the associated PDSCH and/or scheduling scheduled by the first PDCCH, and a duration of a first slot/subslot for the first PDCCH and a second slot/subslot for the associated PDSCH and/or scheduling scheduled by the first PDCCH. For example, the first PDCCH may be in the first slot/subslot. For another example, the associated PDSCH and/or scheduling scheduled by the first PDCCH may be in the second slot/subslot. In some embodiments, the first timing/position may be at least one of: a first/starting symbol of the first PDCCH, a first/starting symbol of the first slot/subslot for the first PDCCH, a first/starting symbol of a span for the first PDCCH monitoring and a first/starting symbol of a first monitoring occasion for the first PDCCH. In some embodiments, the second timing/position may be at least one of: a last/ending symbol of the associated PDSCH and/or scheduling scheduled by the first PDCCH, a last/ending symbol of the second slot/subslot for the associated PDSCH and/or scheduling scheduled by the first PDCCH, a last/ending symbol of the HARQ feedback corresponding to the first PDCCH and/or the associated PDSCH scheduled by the first PDCCH, and a last/ending symbol/slot/subslot overlapped with the threshold or the second time threshold H2. For example, the threshold or the second time threshold H2 may start from the last/ending symbol of the first PDCCH.

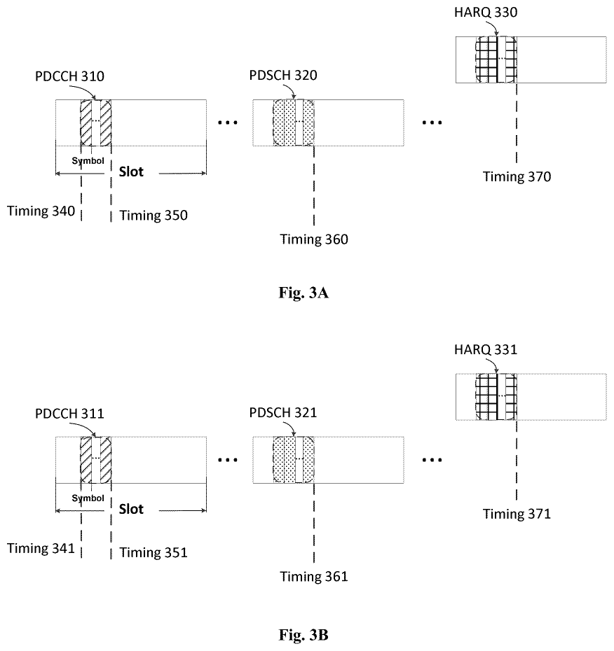

For example, as shown in FIG. 3A, the terminal device 120 may receive, from the network device 110, the first PDCCH (For example PDCCH 310) in the first search space. And the terminal device 120 may receive a PDSCH (For example, PDSCH 320), and the PDSCH is scheduled by the PDCCH 310. For example, the terminal device 120 may transmit a HARQ feedback (For example, HARQ 330) to the network device 110. For example, the Timing 340 may be the first symbol of the PDCCH 310. For another example, the Timing 340 may be the starting or the first symbol of the monitoring occasion for the PDCCH 310. For example, the Timing 350 may be the last symbol of the PDCCH 310. For another example, the Timing 350 may be the ending or the last symbol of the monitoring occasion for the PDCCH 310. For example, the Timing 360 may be the ending or last symbol of the PDSCH 320. For example, the Timing 370 may be the ending or last symbol of the HARQ 330. For example, the HARQ 330 may be transmitted in a PUCCH resource or a PUSCH resource. In some embodiments, the first time duration may be from Timing 340 to Timing 350. In some embodiments, the first time duration may be from Timing 340 to Timing 360. In some embodiments, the first time duration may be from Timing 340 to Timing 370.

In some embodiments, there may be a second time duration, and the second time duration may be at least one of: a duration between a third timing/position and a fourth timing/position, a duration starting from the third timing/position to the fourth timing/position, a duration of a third number of symbols for the second PDCCH and a fourth number of symbols for the associated PDSCH and/or scheduling scheduled by the second PDCCH, and a duration of a third slot/subslot for the second PDCCH and a fourth slot/subslot for the associated PDSCH and/or scheduling scheduled by the second PDCCH. For example, the second PDCCH may be in the third slot/subslot. For another example, the associated PDSCH and/or scheduling scheduled by the second PDCCH may be in the fourth slot/subslot. In some embodiments, the third timing/position may be at least one of: a first/starting symbol of the second PDCCH, a first/starting symbol of the third slot/subslot for the second PDCCH, a first/starting symbol of a span for the second PDCCH monitoring and a first/starting symbol of a second monitoring occasion for the second PDCCH. In some embodiments, the fourth timing/position may be at least one of: a last/ending symbol of the associated PDSCH and/or scheduling scheduled by the second PDCCH, a last/ending symbol of the fourth slot/subslot for the associated PDSCH and/or scheduling scheduled by the second PDCCH and a last/ending symbol/slot/subslot overlapped with the threshold or the second time threshold H2. For example, the threshold or the second time threshold H2 may start from the last/ending symbol of the second PDCCH.

For example, as shown in FIG. 3B, the terminal device 120 may receive, from the network device 110, the second PDCCH (For example PDCCH 311) in the second search space. And the terminal device 120 may receive a PDSCH (For example, PDSCH 321), and the PDSCH is scheduled by the PDCCH 311. For example, the terminal device 120 may transmit a HARQ feedback (For example, HARQ 331) to the network device 110. For example, the Timing 341 may be the first symbol of the PDCCH 311. For another example, the Timing 341 may be the starting or the first symbol of the monitoring occasion for the PDCCH 311. For example, the Timing 351 may be the last symbol of the PDCCH 311. For another example, the Timing 351 may be the ending or the last symbol of the monitoring occasion for the PDCCH 311. For example, the Timing 361 may be the ending or last symbol of the PDSCH 321. For example, the Timing 371 may be the ending or last symbol of the HARQ 331. For example, the HARQ 331 may be transmitted in a PUCCH resource or a PUSCH resource. In some embodiments, the second time duration may be from Timing 341 to Timing 351. In some embodiments, the second time duration may be from Timing 341 to Timing 361. In some embodiments, the second time duration may be from Timing 341 to Timing 371.

In some embodiments, the condition may be at least one of a first condition and a second condition. In some embodiments, the first condition may be at least one of: the first time duration may be overlapped with the second time duration in time domain, any one symbol of the first time duration may be overlapped with any one symbol of the second time duration in time domain, the second monitoring occasion may be in a same time duration with the first monitoring occasion, one or more symbols of the second monitoring occasion may be overlapped with one or more symbols of the first monitoring occasion in time domain, the second monitoring occasion may be fully or partially overlapped with the first monitoring occasion in time domain, any symbol of the second monitoring occasion is overlapped with the first time duration in time domain, any symbol of the fourth number of symbols for the associated PDSCH and/or scheduling scheduled by the second PDCCH is overlapped with the first time duration in time domain, and any symbol of the second monitoring occasion is overlapped with any symbol of the first monitoring occasion in time domain.

In some embodiments, the second condition may be at least one of: the first time duration may be not overlapped with the second time duration in time domain, any one symbol of the first time duration may be not overlapped with any one symbol of the second time duration in time domain, none symbol of the first time duration may be overlapped with any one symbol of the second time duration in time domain, the second monitoring occasion may be in a different timer duration from the first monitoring occasion, none of the symbol of the second monitoring occasion may be overlapped with any symbol of the first monitoring occasion in time domain, any symbol of the second monitoring occasion is not overlapped with any symbol of the first monitoring occasion in time domain, none symbol of the second monitoring occasion is overlapped with the first time duration in time domain, none symbol of the fourth number of symbols for the associated PDSCH and/or scheduling scheduled by the second PDCCH is overlapped with the first time duration in time domain, any symbol of the second monitoring occasion is not overlapped with the first time duration in time domain, any symbol of the fourth number of symbols for the associated PDSCH and/or scheduling scheduled by the second PDCCH is not overlapped with the first time duration in time domain, and the second monitoring occasion may be not overlapped with the first monitoring occasion in time domain.

In some embodiments, the terminal device 120 may monitor or receive the second PDCCH and/or the associated PDSCH and/or scheduling scheduled by the second PDCCH based on the first TCI state after the application timing based on the second condition.

In some embodiments, the terminal device 120 may monitor or receive the second PDCCH and/or the associated PDSCH and/or scheduling scheduled by the second PDCCH based on the second TCI state based on the first condition.

In some embodiments, the terminal device 120 may not monitor or receive the second PDCCH and/or the associated PDSCH and/or scheduling scheduled by the second PDCCH in case of the second condition is satisfied, and if the TCI state or QCL assumption for the second PDCCH and/or the second search space and/or the second CORESET is different from the first TCI state.

In some embodiments, the terminal device 120 may not monitor or receive the second PDCCH and/or the associated PDSCH and/or scheduling scheduled by the second PDCCH in case of the second condition is satisfied, and if the property of qcl_type with typeD configured for the second PDCCH and/or the second search space and/or the second CORESET is different from property of qcl_type with typeD configured for the first TCI state or configured for the first PDCCH and/or the first search space and/or the first CORESET.

In some embodiments, the terminal device 120 may monitor or receive the second PDCCH and/or associated PDSCH and/or scheduling scheduled by the second PDCCH based on the first TCI state after an application timing, based on the condition that the second monitoring occasion and/or the associated PDSCH and/or scheduling is not overlapped with the first time duration in time domain.

In some embodiments, the terminal device 120 may monitor or receive the second PDCCH and/or associated PDSCH and/or scheduling scheduled by the PDCCH based on the first TCI state after an application timing, based on the condition that the second monitoring occasion and/or the symbols of the associated PDSCH and/or scheduling is in a different time duration from the first monitoring occasion or the first time duration. For example, the time duration may be at least one of a slot and a span. For example, the span may be a number of consecutive symbols in a slot. For another example, the span may be a number of consecutive slots.

In some embodiments, the terminal device 120 may monitor or receive the second PDCCH and/or the associated PDSCH and/or scheduling scheduled by the second PDCCH based on the second TCI state or based on the QCL assumption, based on the condition that the second monitoring occasion and/or the associated PDSCH and/or scheduling is overlapped with the first time duration in time domain.

In some embodiments, the terminal device 120 may monitor or receive the second PDCCH and/or the associated PDSCH and/or scheduling scheduled by the second PDCCH based on the second TCI state or based on the QCL assumption, based on the condition that the second monitoring occasion and/or the associated PDSCH and/or scheduling is in a same time duration with the first monitoring occasion or the first time duration. For example, the time duration may be at least one of a slot and a span. For example, the span may be a number of consecutive symbols in a slot. For another example, the span may be a number of consecutive slots.

In some embodiments, the terminal device 120 may monitor or receive the second PDCCH and/or the associated PDSCH and/or scheduling scheduled by the second PDCCH based on the first TCI state after the application timing, based on the condition that the second monitoring occasion and/or the symbols for the associated PDSCH and/or scheduling is not overlapped with the first monitoring occasion or the first time duration in time domain.

In some embodiments, the terminal device 120 may monitor or receive the second PDCCH and/or the associated PDSCH and/or scheduling scheduled by the second PDCCH based on the second TCI state or based on the QCL assumption, based on the condition that the second monitoring occasion and/or the symbols for the associated PDSCH and/or scheduling is overlapped with the first monitoring occasion or the first time duration in time domain.

In some embodiments, the terminal device 120 may not monitor or receive the second PDCCH and/or the associated PDSCH and/or scheduling scheduled by the second PDCCH in case of the second monitoring occasion and/or the symbols for the associated PDSCH and/or scheduling is overlapped with the first monitoring occasion or the first time duration in time domain, and if the property of qcl_type with typeD configured for the second PDCCH and/or the second search space and/or the second CORESET is different from property of qcl_type with typeD configured for the first TCI state or configured for the first PDCCH and/or the first search space and/or the first CORESET.

In some embodiments, the terminal device 120 may receive, from the network device 110, an indication or activation of the second TCI state. For example, via downlink control information (DCI) and/or MAC CE and/or RRC.

In some embodiments, the terminal device 120 may receive, from the network device 110, an indication or activation of the first TCI state. For example, via downlink control information (DCI) and/or MAC CE and/or RRC.

In some embodiments, the first search space may be associated with a first CORESET. In some embodiments, the second search space may be associated with the first CORESET or associate with a second CORESET.

In some embodiments, the first search space may be a common search space (CSS). For example, the search space type for the first search space may be configured as common. In some embodiments, the first search space may be a first user equipment (UE) specific search space (USS). For example, the search space type for the first search space may be configured as UE specific. In some embodiments, the second search space may be a second UE specific search space. For example, the search space type for the second search space may be configured as UE specific.

In some embodiments, there may be a first set of search spaces associated with the first CORESET. In some embodiments, at least one of the first set of search spaces may be a common search space. In some embodiments, search space type of at least one of the first set of search spaces may be configured as common.

In some embodiments, there may be a second set of search spaces associated with the second CORESET. In some embodiments, at least one of the second set of search spaces may be a common search space. In some embodiments, search space type of at least one of the second set of search spaces may be configured as common.

In some embodiments, there may be a second set of search spaces associated with the second CORESET. In some embodiments, all of the second set of search spaces may be UE specific search space. In some embodiments, search space type of all of the second set of search spaces may be configured as UE specific.

In some embodiments, the first TCI state may be indicated to be applied for PDCCH reception(s) for UE specific search space(s) associated with the first CORESET and the second CORESET and/or the associated PDSCH or scheduling scheduled by the PDCCH. In some embodiments, the first TCI state may not be applied for PDCCH reception(s) for common search space(s) associated with the first CORESET and/or the second CORESET and/or the associated PDSCH or scheduling scheduled by the PDCCH.

In some embodiments, the first TCI state may be indicated to be applied for PDCCH reception(s) for all of search space(s) associated with the second CORESET, in case of all search spaces associated with the second CORESET are UE specific search spaces.

In some embodiments, the second TCI state may be indicated to be applied for PDCCH reception(s) for the first search space or for PDCCH reception(s) for all search spaces associated with the first CORESET. In some embodiments, the second TCI state may be indicated to be applied for PDCCH reception(s) for any common search space which is associated with the first CORESET and/or the second CORESET.

In some embodiments, the second physical cell ID may be a physical cell ID of a serving cell configured for the terminal device 120. In some embodiments, the first physical cell ID may be different from the physical cell ID of the serving cell. For example, the serving cell may be provided by the network 100.

In some embodiments, in case of the terminal device 120 monitors or receives a PDCCH based on a TCI state, the terminal device 120 may assume that a DM-RS antenna port for the PDCCH reception is quasi co-located with the one or more RS configured by or in the TCI state.

In some embodiments, in case of the terminal device 120 monitors or receives a PDCCH or PDSCH based on a TCI state, the terminal device 120 may assume that the DM-RS antenna port(s) for the PDCCH or PDSCH reception is quasi co-located with the one or more RS configured by or in the TCI state.

In some embodiments, in case of the terminal device 120 monitors or receives a PDSCH based on a TCI state, the terminal device 120 may assume that the DM-RS port(s) of the PDSCH is quasi co-located with the RS(s) in the TCI state with respect to the QCL type parameter(s) given by the TCI state.

In some embodiments, in case of the terminal device 120 monitors or receives a PDCCH based on a QCL assumption, the terminal device 120 may assume that a DM-RS antenna port for the PDCCH reception is quasi co-located with a SS/PBCH block. For example, the terminal device 120 may identify the SS/PBCH block during a random access procedure. For example, the random access procedure may be a most recent random access procedure not initiated by a PDCCH order that triggers a contention-free random access procedure. For another example, the terminal device 120 may identify the SS/PBCH block during initial access procedure.

In some embodiments, the terminal device 120 may be configured with two subsets (for example, a first subset and a second subset) of TCI states. For example, via at least one of MAC CE and RRC. In some embodiments, the TCI states in the first subset are associated with the second physical cell ID. In some embodiments, the TCI states in the second subset are associated with the first physical cell ID. In some embodiments, the second subset of TCI states may be configured or added after the first subset of TCI states. In some embodiments, there may be S_1 TCI states in the first subset, S_1 is non-negative integer. For example, 0<=S_1<=128. In some embodiments, there may be S_2 TCI states in the second subset, S_2 is non-negative integer. For example, 0<=S_2<=128. In some embodiments, the index for a TCI state in the first subset may be any one of {0, 1, . . . . S_1−1}. In some embodiments, the index for a TCI state in the second subset may be any one of {S_1, S_1+1 . . . . S_1+S_2−1}.

In some embodiments, the terminal device 120 may determine a set of reference signals to include CSI-RS index(es) with same value(s) as the RS index(es) indicated by TCI-state for at least one CORESET. In some embodiments, the terminal device 120 may determine a set of reference signals to include CSI-RS index(es) with same value(s) as the RS index(es) indicated by one or more TCI-states for at least one CORESET, wherein the one or more TCI states may be associated with the second physical cell ID. For example, the set of reference signals may be applied for beam failure detection. For example, the CSI-RS may be periodic CSI-RS. For example, the at least one CORESET may be applied or used for the terminal device 120 for monitoring PDCCH. In some embodiments, if there are two RS indexes in a TCI state, the set of reference signals include RS index(es) configured with qcl-Type set to typeD for the corresponding TCI states. In some embodiments, the TCI state(s) indicated for the at least one CORESET is associated with the second physical cell ID. In some embodiments, the CSI-RS included in the set of reference signals may be associated with the second physical cell ID. In some embodiments, the set of reference signals may not include CSI-RS index(es) with same value(s) as the RS index(es) indicated by a TCI-state for a CORESET, if the TCI-state is associated with the first physical cell ID.

In some embodiments, the terminal device 120 may be configured with a CORESET, and the CORESET is associated with a common search space and a UE specific search space. In some embodiments, the second TCI state may be indicated or activated or configured or applied for the common search space, and the first TCI state may be indicated or activated or configured or applied for the UE specific search space. In some embodiments, the terminal device 120 may determine a set of reference signals to include CSI-RS index(es) with same value(s) as the RS index(es) indicated by the first TCI state for the CORESET.

In some embodiments, the terminal device 120 may be activated with one or two groups of TCI states based on the two subsets of TCI states (for example, a first group and/or a second group). For example, via MAC CE. In some embodiments, the one or two groups of TCI states activation may be based on the order of TCI state(s) in first subset, and then TCI state(s) in the second subset. In some embodiments, the one or two groups of TCI states activation may be based on the order of TCI state(s) which associated with the second physical cell ID, and then TCI state(s) which associated with the first physical cell ID.

In some embodiments, there may be a first TCI state activation command (For example, via MAC CE. For example, represented as Command_1), and the Command_1 may be applied to activate TCI state(s) for a set of channels and reference signals (For example, for PDCCH reception(s) for UE specific search space(s) associated with the first CORESET and the second CORESET and/or the associated PDSCH or scheduling scheduled by the PDCCH. For another example, for the PDCCH in the first CORESET and/or the second CORESET and the associated PDSCH or scheduling scheduled by the PDCCH). For example, the first TCI state and/or the second TCI state may be activated based on Command_1. For example, in Command_1, there may be no indication of index of a CORESET.

In some embodiments, there may be a second TCI state activation command (For example, via MAC CE. For example, represented as Command_2), and the Command_2 may be applied to activate TCI state(s) for a CORESET and/or a common search space of a CORESET (For example, for the first search space and/or the first CORESET). For example, the second TCI state may be activated based on Command_2. For example, in Command_2, there may be an indication of index of a CORESET.

In some embodiments, there may be a third TCI state activation command (For example, via MAC CE. For example, represented as Command_3), and the Command 3 may be applied to activate TCI state(s) for PDSCH (For example, UE-specific PDSCH MAC CE as defined in TS 38.321). In some embodiments, the terminal device 120 may not expect to receive both of Command_1 and Command_3. In some embodiments, in case of the terminal device 120 receives Command_1, the terminal device 120 may not expect to receive Command_3. In some embodiments, in case of the terminal device 120 receives Command_1, and if the terminal device 120 receives Command_3, the activated TCI states in the Command_3 may be applied for PDSCH scheduled by a PDCCH, wherein the PDCCH is in the CORESET whose TCI state is activated based on Command_2. In some embodiments, the TCI states activated based on the Command_3 may be a subset of the TCI states activated based on the Command_1.

In some embodiments, the terminal device 120 may be configured to not apply the second TCI state for the first search space and/or the first CORESET.

In some embodiments, the terminal device 120 may monitor or receive a PDCCH in the first search space, and the terminal device 120 may assume the DM-RS antenna port associated with the PDCCH reception is quasi co-located with corresponding SS/PBCH block, if the terminal device 120 is not provided a TCI state with Rel-15/16 MAC CE (for example, Command_2) for the CORESET, and the terminal device 120 may assume the DM-RS antenna port associated with the PDCCH reception is quasi co-located with the one or more DL RS configured by a TCI state, which is indicated by Rel-15/16 MAC CE (for example, Command_2) for the CORESET. In some embodiments, the terminal device 120 may receive a PDSCH scheduled by the PDCCH. In some embodiments, the TCI state or QCL assumption for the PDSCH is identical to the TCI state or QCL assumption for the corresponding PDCCH. For example, regardless of scheduling offset equal to or greater than or less than the threshold. For example, the terminal device 120 may ignore the TCI field in the DCI in the PDCCH (For example, for some Type 3 CSS). In some embodiments, the TCI field present or not is separately configured for the common search space and the UE specific search space in a same CORESET. For example, TCI field may be configured as absent or disabled for the common search space. For another example, TCI field present or not may be based on the number of activated TCI states or codepoints (for example, based on Command_1) for UE specific search space. In some embodiments, Rel-15/16 MAC CE (For example, Command_3) for activation TCI states for PDSCH may be needed in addition to Rel-17 MAC CE for Rel-17 TCI state activation (For example, Command_1).

In some embodiments, the TCI state(s) activated via Rel-15/16 MAC CE (For example. Command_3) may be only applied to PDSCH scheduled by PDCCH in common search space (For example, for the PDCCH in a search space which does not apply indicated Rel-17 TCI state).

In some embodiments, in case of scheduling offset for PDSCH less than threshold, the terminal device 120 may assume that the DM-RS port(s) of PDSCH is quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the terminal device 120. For example, the one or more CORESETs may include common search spaces. For another example, the one or more CORESETs and/or the common search spaces may not apply the indicated or activated Rel-17 TCI state (For example, based on Command_1).

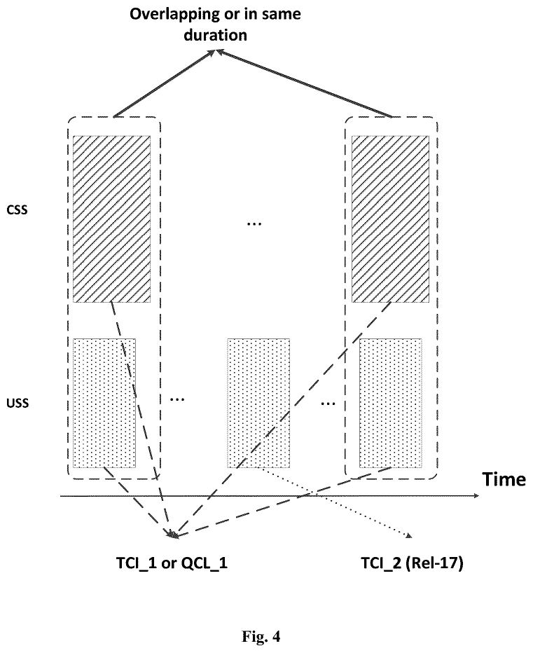

For example, as shown in FIG. 4, the terminal device 120 may be configured with a second TCI state (for example, TCI_1 or QCL_1) to monitor or receive a PDCCH in a common search space. In some embodiments, the terminal device 120 may be configured with a first TCI state (for example, TCI_2) to monitor or receive a PDCCH in a UE specific search space. In some embodiments, in case of the common search space and the UE specific search space overlap in time domain or in same duration, the terminal device 120 may receive the PDCCH in the UE specific search space in the overlapping duration or in the same duration based on the second TCI state (TCI_1 or QCL_1 as shown in FIG. 4). In some embodiments, in case of a duration for the UE specific search space is not overlapped with CSS, the terminal device 120 may receive a PDCCH in the UE specific search space in the duration based on the first TCI state (TCI_2 as shown in FIG. 4).

In some embodiments, the terminal device 120 may be indicated with the first TCI state. For example, the terminal device 120 may monitor or receive a PDCCH in a USS in a CORESET in a duration based on the first TCI state, in case of the duration is not overlapped with the first time duration. In some embodiments, the terminal device may monitor or receive a PDCCH in a USS and/or in a CSS starting from the first symbol of a monitoring occasion for any CSS based on the second TCI state.

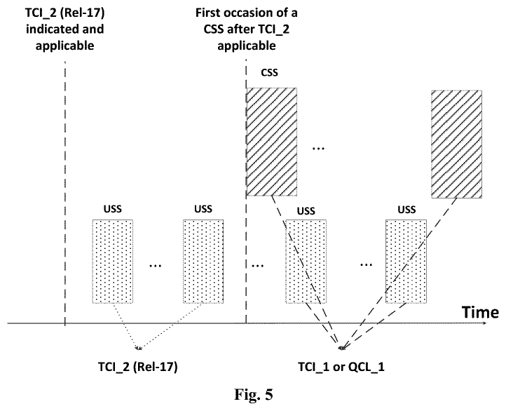

For example, as shown in FIG. 5, the terminal device 120 may be configured with a second TCI state (for example, TCI_1 or QCL_1) to monitor or receive a PDCCH in a common search space. In some embodiments, the terminal device 120 may be configured with a first TCI state (for example, TCI_2) to monitor or receive a PDCCH in a UE specific search space. In some embodiments, in a duration starting from the first TCI state is applicable to the starting of the first occasion of a CSS, the terminal device 120 may receive the PDCCH in a USS based on the first TCI state (TCI_2 as shown in FIG. 5). In some embodiments, starting from the starting of the first occasion of a CSS, the terminal device 120 may receive a PDCCH in a USS and/or in a CSS based on the second TCI state (TCI_1 or QCL_1 as shown in FIG. 5).

In some embodiments, the terminal device 120 may be configured with a CORESET. And the CORESET is associated with a common search space and a UE specific search space. In some embodiments, the terminal device 120 may be indicated or activated with the first TCI state (For example, Command_1), and the terminal device 120 may be indicated or activated with the second TCI state (For example, Command_2). In some embodiments, the terminal device 120 may monitor or receive a PDCCH in the common search space based on the second TCI state. In some embodiments, the second TCI state may be indicated or activated no earlier than the first TCI state. For example, the terminal device 120 may monitor or receive a PDCCH in the UE specific search space based on the first TCI state. For example, the UE specific search space is not overlapped with the common search space.

In some embodiments, the terminal device 120 may be indicated or activated with the second TCI state (For example, Command_2), and the terminal device 120 may be indicated or activated with the first TCI state (For example, Command_1). In some embodiments, the terminal device 120 may monitor or receive a PDCCH in the common search space and/or in the UE specific search space based on the second TCI state. In some embodiments, the first TCI state may be indicated or activated no earlier than the second TCI state. For example, the terminal device 120 may monitor or receive a PDCCH in the UE specific search space based on the first TCI state after the application timing. For example, the UE specific search space is not overlapped with the common search space.

In some embodiments, the terminal device 120 may receive indication or activation of a Rel-17 TCI state (e.g. joint TCI state or separate DL and/or UL TCI state), if the Rel-17 TCI state is associated with physical cell ID of serving cell or the second physical cell ID (e.g. the second TCI state), the TCI state is applied to a first set of signals and channels (e.g. all signals and channels for intra-cell beam management (e.g. aperiodic CSI-RS for beam management, aperiodic CSI-RS for channel state information (CSI), UE dedicated PDSCH, CORESETs and non-UE dedicated CORESETs and associated PDSCH), and if the Rel-17 TCI state is associated with physical cell ID different from serving cell or the first physical cell ID (e.g. the first TCI state), the TCI state is applied to a second set of signals and channels (e.g. the first set excluding non-UE dedicated signals and channels).

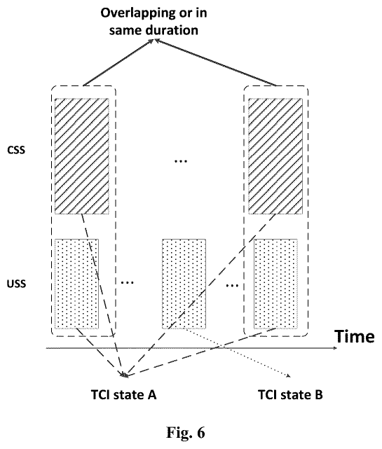

For example, as shown in FIG. 6, the terminal device 120 may be configured with a second TCI state (for example, TCI state A) to monitor or receive a PDCCH in a common search space. For example, the TCI state A may be associated with the second physical cell ID. In some embodiments, the terminal device 120 may be configured with a first TCI state (for example, TCI state B) to monitor or receive a PDCCH in a UE specific search space. For example, the TCI state B may be associated with the first physical cell ID. In some embodiments, in case of the common search space and the UE specific search space overlap in time domain or in same duration, the terminal device 120 may receive the PDCCH in the UE specific search space in the overlapping duration or in the same duration based on the second TCI state (TCI state A as shown in FIG. 6). In some embodiments, in case of a duration for the UE specific search space is not overlapped with CSS, the terminal device 120 may receive a PDCCH in the UE specific search space in the duration based on the first TCI state (TCI state B as shown in FIG. 6).

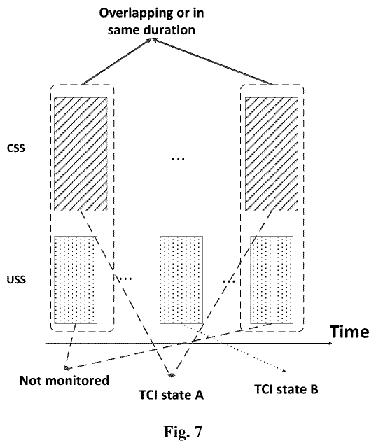

For example, as shown in FIG. 7, the terminal device 120 may be configured with a second TCI state (for example, TCI state A) to monitor or receive a PDCCH in a common search space. For example, the TCI state A may be associated with the second physical cell ID. In some embodiments, the terminal device 120 may be configured with a first TCI state (for example, TCI state B) to monitor or receive a PDCCH in a UE specific search space. For example, the TCI state B may be associated with the first physical cell ID. In some embodiments, in case of the common search space and the UE specific search space overlap in time domain or in same duration, the terminal device 120 may not monitor or receive the PDCCH in the UE specific search space in the overlapping duration or in the same duration. For example, the terminal device 120 may monitor or receive a PDCCH in the common search space in the overlapping duration or in the same duration based on the TCI state A. In some embodiments, in case of a duration for the UE specific search space is not overlapped with CSS, the terminal device 120 may receive a PDCCH in the UE specific search space in the duration based on the first TCI state (TCI state B as shown in FIG. 7).

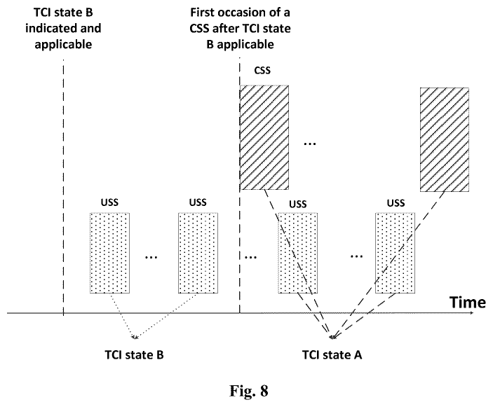

For example, as shown in FIG. 8, the terminal device 120 may be configured with a second TCI state (for example, TCI state A) to monitor or receive a PDCCH in a common search space. In some embodiments, the terminal device 120 may be configured with a first TCI state (for example, TCI state B) to monitor or receive a PDCCH in a UE specific search space. In some embodiments, in a duration starting from the first TCI state is applicable to the starting of the first occasion of a CSS, the terminal device 120 may receive the PDCCH in a USS based on the first TCI state (TCI state B as shown in FIG. 8). In some embodiments, starting from the starting of the first occasion of a CSS, the terminal device 120 may receive a PDCCH in a USS and/or in a CSS based on the second TCI state (TCI state A as shown in FIG. 8).

In some embodiments, if a UE
is configured for single cell operation or for operation with carrier aggregation in a same frequency band, and
monitors PDCCH candidates in overlapping PDCCH monitoring occasions in multiple CORESETs or in multiple search space sets in a CORESET that have been configured with same or different qcl-Type set to ‘typeD’ properties on active DL BWP(s) of one or more cells
   the UE monitors PDCCHs only in a CORESET or a search space set, and in any other CORESET from the multiple CORESETs or in any other search space set from the multiple search space sets that have been configured with qcl-Type set to same ‘typeD’ properties as the CORESET or the search space set, on the active DL BWP of a cell from the one or more cells
the CORESET corresponds to the CSS set with the lowest index in the cell with the lowest index containing CSS, if any: otherwise, to the USS set with the lowest index in the cell with lowest index if all search space sets are configured with qcl-Type set to same ‘typeD’ properties in each CORESET
the CSS set with the lowest index in the cell with the lowest index containing CSS, if any: otherwise, the USS set with the lowest index in the cell with lowest index, if search space sets are configured with qcl-Type set to different ‘typeD’ properties in a CORESET
the lowest USS set index is determined over all USS sets with at least one PDCCH candidate in overlapping PDCCH monitoring occasions
for the purpose of determining the CORESET, a SS/PBCH block is considered to have different QCL ‘typeD’ properties than a CSI-RS
for the purpose of determining the CORESET, a first CSI-RS associated with a SS/PBCH block in a first cell and a second CSI-RS in a second cell that is also associated with the SS/PBCH block are assumed to have same QCL ‘typeD’ properties
the allocation of non-overlapping CCEs and of PDCCH candidates for PDCCH monitoring is according to all search space sets associated with the multiple CORESETs on the active DL BWP(s) of the one or more cells
the number of active TCI states is determined from the multiple CORESETs and number of PCIs different from the serving cell

In some embodiments, if a UE
is configured for single cell operation or for operation with carrier aggregation in a same frequency band, and
monitors PDCCH candidates in overlapping PDCCH monitoring occasions in multiple CORESETs where none of the CORESETs has TCI-states configured with qcl-Type set to ‘typeD’,
   the UE is required to monitor PDCCH candidates in overlapping PDCCH monitoring occasions for search space sets associated with different CORESETs.

In some embodiments, for a CORESET other than a CORESET with index 0, if a UE is provided a single TCI state for a CORESET, or if the UE receives a MAC CE activation command for one of the provided TCI states for a CORESET, the UE assumes that the DM-RS antenna port associated with PDCCH receptions in the CORESET is quasi co-located with the one or more DL RS configured by the TCI state. For a CORESET with index 0, the UE expects that a CSI-RS configured with qcl-Type set to ‘typeD’ in a TCI state indicated by a MAC CE activation command or a DCI for the CORESET is provided by a SS/PBCH block associated with PCI of the serving cell if the TCI state is associated with PCI of the serving cell, and the UE expects that a CSI-RS configured with qcl-Type set to ‘typeD’ in a TCI state indicated by a MAC CE activation command or a DCI for the (USS of the) CORESET is provided by a SS/PBCH block associated with a different PCI from the serving cell if the TCI state is associated with a different PCI of the serving cell
if the UE receives a MAC CE activation command for one of the TCI states, the UE applies the activation command in the first slot that is after slot k+3Nₛₗₒₜ^{subframe,μ} where k is the slot where the UE would transmit a PUCCH with HARQ-ACK information for the PDSCH providing the activation command and u is the SCS configuration for the PUCCH. The active BWP is defined as the active BWP in the slot when the activation command is applied.

In some embodiments, the UE determines the set q̅ₒ to include periodic CSI-RS resource configuration indexes with same values as the RS indexes in the RS sets indicated by TCI-State for respective CORESETs that the UE uses for monitoring PDCCH, wherein the CORESETs are configured with a same value of CORESETPoolIndex and the TCI-state is associated with physical cell ID of the serving cell, and, if there are two RS indexes in a TCI state, the set q̅ₒ includes RS indexes configured with qcl-Type set to ‘typeD’ for the corresponding TCI states. The UE expects the set q̅ₒ to include up to two RS indexes.

In some embodiments, the terminal device 120 may be configured with a common search space (CSS) and a UE specific search space (USS). For example, the CSS and the USS may be associated with a same CORESET. For another example, the CSS and the USS may be associated with different CORESETs. In some embodiments, there may be a first TCI field in a DCI in PDCCH for the CSS. In some embodiments, any one of the codepoint for the first TCI field may be only associated with TCI states associated with the second physical cell ID. In some embodiments, there may be a second TCI field in a DCI in PDCCH for the USS. In some embodiments, the codepoint(s) for the second TCI field may be associated with TCI states associated with the second physical cell ID and with TCI states associated with the first physical cell ID. In some embodiments, some codepoint(s) for the second TCI field may be associated with TCI states associated with the second physical cell ID and other codepoint(s) for the second TCI field may be associated with TCI states associated with the first physical cell ID.

In some embodiments, the terminal device 120 may receive a first DCI in a PDCCH, and the first DCI may indicate the first TCI state. For example, the first TCI state may be associated with the first physical cell ID. The terminal device 120 may receive a second DCI in another PDCCH, and the second DCI may indicate the second TCI state. For example, the second TCI state may be associated with the second physical cell ID. In some embodiments, the HARQ feedback corresponding to the first DCI or corresponding to a PDSCH scheduled by the first DCI and the HARQ feedback corresponding to the second DCI or corresponding to a PDSCH scheduled by the second DCI may be in a same HARQ codebook. For example, the HARQ codebook may be transmitted in a PUCCH resource or in a PUSCH resource. In some embodiments, after the application timing, the first TCI state and the second TCI state may be applicable. For example, the first TCI state may be applied to PDCCH reception(s) in a UE specific search space. For another example, the second TCI state may be applied to PDCCH reception(s) in a common search space.

In some embodiments, the terminal device may be configured with separate downlink and uplink TCI states. In some embodiments, the terminal device 120 may receive a first DCI in a PDCCH, and the first DCI may indicate the first TCI state. For example, the first TCI state may be a downlink TCI state or a pair of downlink TCI state and uplink TCI state or an uplink TCI state. The terminal device 120 may receive a second DCI in another PDCCH, and the second DCI may indicate the second TCI state. For example, the second TCI state may be an uplink TCI state or a downlink TCI state. In some embodiments, the HARQ feedback corresponding to the first DCI or corresponding to a PDSCH scheduled by the first DCI and the HARQ feedback corresponding to the second DCI or corresponding to a PDSCH scheduled by the second DCI may be in a same HARQ codebook. For example, the HARQ codebook may be transmitted in a PUCCH resource or in a PUSCH resource. In some embodiments, after the application timing, both of the first TCI state and the second TCI state may be applicable. In some embodiments, downlink TCI state in the first TCI state may be applied to downlink channels and/or reference signals, and the second TCI state may be applied to uplink channels and/or reference signals. For example, the first TCI state may be a downlink TCI state or a pair of downlink TCI state and uplink TCI state, and the second TCI state may be an uplink TCI state. In some embodiments, uplink TCI state in the first TCI state may be applied to uplink channels and/or reference signals, and the second TCI state may be applied to downlink channels and/or reference signals. For example, the first TCI state may be an uplink TCI state or a pair of downlink TCI state and uplink TCI state, and the second TCI state may be a downlink TCI state.

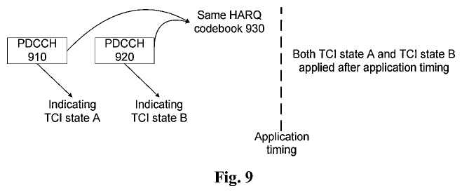

For example, as shown in FIG. 9, the terminal device 120 may receive a PDCCH 910 and a PDCCH 920. For example, DCI in PDCCH 910 may indicate the first TCI state (TCI state A as shown in FIG. 9). For another example, DCI in PDCCH 920 may indicate the second TCI state (TCI state B as shown in FIG. 9). The terminal device 120 may apply both the first TCI state and the second TCI state after application timing to corresponding channels and/or RSs, respectively.

In some embodiments, the terminal device 120 may be configured with a first CORESET or a first search space, and a second CORESET or a second search space. In some embodiments, if the first CORESET or the first search space follows indicated Rel-17 TCI state. For example, the first TCI state or TCI state associated with the second physical cell ID. And the second CORESET or the second search space follows indicated Rel-17 TCI state. For example, the first TCI state or the second TCI state or TCI state associated with either one of the first physical cell ID or the second physical cell ID. In some embodiments, the codepoint in TCI field in PDCCH of the first CORESET or the first search space mapping with activated TCI states associated with the second physical cell ID only (e.g. in order). In some embodiments, the codepoint in TCI field in PDCCH of the second CORESET or the second search space mapping with activated TCI states (e.g. in order). For example, the TCI states are activated via Command_1.

In some embodiments, only TCI state associated with the second physical cell ID can be applied to CORESET 0. In some embodiments, if the CORESET 0 is associated with a common search space and a UE specific search space, only TCI state associated with the second physical cell ID can be applied to the common search space, and TCI state associated with either the first physical cell ID or the second physical cell ID can be applied to the UE specific search space.

In some embodiments, the terminal device 120 may receive a first indication or configuration or activation of a first set of TCI states for a first set of CORESETs, and the terminal device 120 may receive a second indication or configuration or activation of a second set of TCI states for a second set of CORESETs. In some embodiments, the terminal device 120 may perform one or two beam failure recovery procedures based on a condition.

In some embodiments, the condition may be at least one of a third condition and a fourth condition. In some embodiments, the third condition may be a second set of reference signals (RSs) in the second set of TCI states is associated with the first physical cell ID. In some embodiments, the fourth condition may be a second set of reference signals (RSs) in the second set of TCI states is associated with the second physical cell ID.

In some embodiments, based on the third condition, the terminal device 120 may perform a first beam failure detection based on a first set of RSs in the first set of TCI states.

In some embodiments, based on the fourth condition, the terminal device 120 may perform the first beam failure detection based on the first set of RSs in the first set of TCI states, and perform a second beam failure detection based on the second set of RSs in the second set of TCI states.

In some embodiments, the first set of RSs in the first set of TCI states may be associated with the second physical cell ID. In some embodiments, the second physical cell ID is a physical cell ID of a serving cell configured for the terminal device 120. In some embodiments, the first physical cell ID may be different from the physical cell ID of the serving cell.

In some embodiments, a first set of beam failure detection (BFD) RSs for the terminal device may be determined based on the first set of RSs in the first set of TCI states.

In some embodiments, a second set of beam failure detection RSs for the terminal device may be determined based on the second set of RSs in the second set of TCI states, in case of the second set of RSs in the second set of TCI states is associated with the second physical cell ID.

In some embodiments, no beam failure detection RS may be determined based on the second set of RSs in the second set of TCI states, in case of the second set of reference signals (RSs) in the second set of TCI states is associated with the first physical cell ID.

In some embodiments, in case of one or more TCI states activated for a first value of CORESETPoolIndex are associated with the second physical cell ID, and one or more TCI states activated for a second value of CORESETPoolIndex are also associated with the second physical cell ID. TRP specific BFR can be applied. For example, for the first set of CORESETs associated with first value of CORESETPoolIndex (e.g. TRP1), beam failure detection (BFD) RS set 1 (e.g. BFD_set_1) may be applied for beam failure detection, and new beam identification (NBI) RS set 1 (e.g. NBI_set_1) may be applied for candidate beam identification. For TRP2, BFD RS set 2 (e.g. BFD_set_2) may be applied for beam failure detection, and NBI RS set 2 (e.g. NBI_set_2) may be applied for candidate beam identification.

In some embodiments, if one or more TCI states is indicated or activated for one value of CORESETPoolIndex associated with the first physical cell ID, then TRP specific BFR may be changed to cell-specific BFR. For example, only one set of BFD RS set is applied for beam failure detection, and in case of implicit configuration, BFD RS is based on the CORESETs whose TCI states are associated with the second physical cell ID.

In some embodiments, the terminal device 120 may determine the first set of BFD RSs to include CSI-RS index(es) with same value(s) as the RS index(es) indicated by one or more TCI-state for CORESETs configured with the first value of CORESETPoolIndex, and the one or more TCI-states for the CORESETs are associated with the second physical cell ID. In some embodiments, the terminal device 120 may determine the second set of BFD RSs to include CSI-RS index(es) with same value(s) as the RS index(es) indicated by one or more TCI-state for CORESETs configured with the second value of CORESETPoolIndex, and the one or more TCI-states for the CORESETs are associated with the second physical cell ID. For example, the set of reference signals may be applied for beam failure detection. For example, the CSI-RS may be periodic CSI-RS. For example, the CORESETs may be applied or used for the terminal device 120 for monitoring PDCCH. In some embodiments, if there are two RS indexes in a TCI state, the set of reference signals include RS index(es) configured with qcl-Type set to typeD for the corresponding TCI states. In some embodiments, the TCI state(s) indicated for the CORESETs is associated with the second physical cell ID. In some embodiments, the CSI-RS included in the set of reference signals may be associated with the second physical cell ID. In some embodiments, the set of reference signals may not include CSI-RS index(es) with same value(s) as the RS index(es) indicated by a TCI-state for a CORESET, if the TCI-state is associated with the first physical cell ID.

In some embodiments, the terminal device 120 may be configured with a CORESET, and the CORESET is associated with a common search space and a UE specific search space. In some embodiments, the second TCI state may be indicated or activated or configured or applied for the common search space, and the first TCI state may be indicated or activated or configured or applied for the UE specific search space. In some embodiments, the terminal device 120 may determine the set of reference signals or the first set of BFD RSs or the second set of BFD RSs to include CSI-RS index(es) with same value(s) as the RS index(es) indicated by the first TCI state for the CORESET.

In some embodiments, in case of all TCI states for all CORESETs configured with the first value of CORESETPoolIndex are associated with the first physical cell ID, there may be no first set of BFD RSs or the terminal device 120 may not perform beam failure detection based on the first set of BFD RSs or the terminal device 120 may not perform beam failure detection for the first TRP or for the CORESETs configured with the first value of CORESETPoolIndex. In some embodiments, in case of all TCI states for all CORESETs configured with the second value of CORESETPoolIndex are associated with the first physical cell ID, there may be no second set of BFD RSs or the terminal device 120 may not perform beam failure detection based on the second set of BFD RSs or the terminal device 120 may not perform beam failure detection for the second TRP or for the CORESETs configured with the second value of CORESETPoolIndex.

In some embodiments, there may be a first SS and/or a first PBCH associated with the first physical cell ID, and there may be a second SS and/or a second PBCH associated with the second physical cell ID. In some embodiments, the terminal device 120 may perform the communication with the network device 110 based on a first payload or first information in the second SS and/or the second PBCH. For example, the first payload or first information may include at least one of system frame number, half frame indication and subframe index. In some embodiments, the terminal device 120 may ignore a second payload or second information in the first SS and/or the first PBCH. For example, the second payload or second information may include at least one of system frame number, half frame indication and subframe index.

In some embodiments, a sequence for the RS may be generated based on the information associated with the second physical cell ID. For example, the information may include at least one of system frame number, half frame indication, subframe index, symbol index and scrambling ID.

In some embodiments, the terminal device 120 may be configured with a pair of linked PDCCH candidates. For example, a first PDCCH candidate and a second PDCCH candidate. In some embodiments, the first PDCCH candidate may be associated with a first search space, and the second PDCCH candidate may be associated with a second search space. In some embodiments, if one of the linked PDCCH candidates uses same set of control channel elements (CCEs) as an individual (e.g. unlinked) PDCCH candidate (for example, a third PDCCH candidate), and they both are associated with same DCI size, scrambling and CORESET. For example, the third PDCCH candidate may be associated with a third search space. In some embodiments, the terminal device 120 may determine PUCCH resource based on a lower index between the index of the first search space and the index of the second search space for a DCI in at least one of the first PDCCH candidate, the second PDCCH candidate and the third PDCCH candidate. In some embodiments, the terminal device 120 may determine PUCCH resource based on a lowest index among the index of the first search space, the index of the second search space and the index of the third search space for a DCI in at least one of the first PDCCH candidate, the second PDCCH candidate and the third PDCCH candidate. In some embodiments, the terminal device 120 may not expect to monitor or receive PDCCH in case of both of the linked PDCCH candidates overlap with the third PDCCH candidate and a fourth PDCCH candidate. In some embodiments, the terminal device 120 may not expect to monitor or receive PDCCH in case of the first PDCCH candidate overlaps with the third PDCCH candidate, and the second PDCCH candidate overlaps with a fourth PDCCH candidate.

In one embodiment, a method performed by the network device 110 is provided. In the method, the indication of the first transmission configuration indicator (TCI) state may be transmitted to the terminal device 120. At least one reference signal (RS) in the first TCI state may be associated with the first physical cell identity (ID). The first physical downlink control channel (PDCCH) in the first monitoring occasion for the first search space may be transmitted to the terminal device based on the second TCI state or based on the quasi co-location (QCL). At least one RS in the second TCI state and the QCL assumption may be associated with the second physical cell ID. The second PDCCH in the second monitoring occasion for the second search space based on the condition.

The method performed by the network device 110 may further include at least one of: transmitting the second PDCCH based on the first TCI state after an application timing, based on the condition that the second monitoring occasion is in a different time duration from the first time duration: transmitting the second PDCCH based on the second TCI state or based on the QCL assumption, based on the condition that the second monitoring occasion is in a same time duration with the first time duration: transmitting the second PDCCH based on the first TCI state after the application timing, based on the condition that the second monitoring occasion is not overlapped with the first time duration in time domain; and transmitting the second PDCCH based on the second TCI state or based on the QCL assumption, based on the condition that the second monitoring occasion is overlapped with the first time duration in time domain.

It should be noted that features, parameters, and steps mentioned in the method performed by the network device 110 has been described in the method performed by the terminal device 120. Therefore, those disclosure would be considered as parts of the method performed by the network device 110.

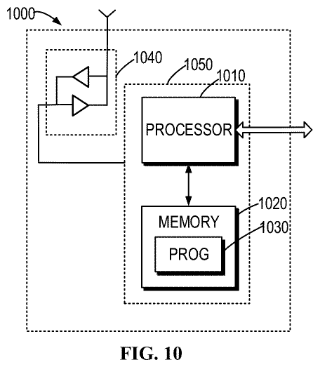

FIG. 10 is a simplified block diagram of a device 1000 that is suitable for implementing embodiments of the present disclosure. The device 1000 can be considered as a further example implementation of the network device 110, the TRP 130 and/or the terminal device 120 as shown in FIG. 1. Accordingly, the device 1000 can be implemented at or as at least a part of the network device 110, the TRP 130 and/or the terminal device 120 as shown in FIG. 1.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between eNBs, SI interface for communication between a Mobility Management Entity (MME)/Serving Gateway (S-GW) and the eNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure, as discussed herein with reference to FIG. 1 to FIG. 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 14. Generally; program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-25. (canceled)

26: A method, performed by a terminal device, comprising:
receiving, from a network device, a first transmission configuration indicator (TCI) state and a second TCI state,
monitoring a first physical downlink control channel (PDCCH) in a first monitoring occasion, based on the second TCI state, in a second control resource set (CORESET), and
monitoring a second PDCCH in a second monitoring occasion, based on the first TCI state, in a first CORESET, in a case where the second monitoring occasion is overlapping with the first monitoring occasion,
wherein, the second CORESET is associated only with user equipment (UE) specific search space, and the first CORESET is associated with at least one common search space.

27: The method of claim 26, wherein:
the second CORESET is associated with a physical cell ID of a serving cell, and the first CORESET is associated with another physical cell ID different from the physical cell ID of the serving cell.

28: The method of claim 26, wherein:
both the first CORESET and the second CORESET are configured with a same quasi co-location (QCL) type, the same QCL type comprises a spatial receiver (Rx) parameter.

29: The method of claim 26, wherein
a demodulation reference signal (DMRS) antenna port for the first PDCCH is quasi co-located with at least one RS configured in the second TCI state; and
a DMRS antenna port for the second PDCCH is quasi co-located with at least one RS configured in the first TCI state.

30: A method, performed by a network device, comprising:
transmitting, to a terminal device, a first transmission configuration indicator (TCI) state and a second TCI state,
wherein:
the second TCI state is used for monitoring a first physical downlink control channel (PDCCH) in a first monitoring occasion, in a second control resource set (CORESET), and
the first TCI state is used for monitoring a second PDCCH in a second monitoring occasion, in a first CORESET, in a case where the second monitoring occasion is overlapping with the first monitoring occasion,
wherein, the second CORESET is associated only with user equipment (UE) specific search space, and the first CORESET is associated with at least one common search space.

31: The method of claim 30, wherein:
the second CORESET is associated with a physical cell ID of a serving cell, and the first CORESET is associated with another physical cell ID different from the physical cell ID of the serving cell.

32: The method of claim 30, wherein:
both the first CORESET and the second CORESET are configured with a same quasi co-location (QCL) type, the same QCL type comprises a spatial receiver (Rx) parameter.

33: The method of claim 30, wherein
a demodulation reference signal (DMRS) antenna port for the first PDCCH is quasi co-located with at least one RS configured in the second TCI state; and
a DMRS antenna port for the second PDCCH is quasi co-located with at least one RS configured in the first TCI state.

34: A terminal device, comprising a processor configured to cause the terminal device to:
receive, from a network device, a first transmission configuration indicator (TCI) state and a second TCI state,
monitor a first physical downlink control channel (PDCCH) in a first monitoring occasion, based on the second TCI state, in a second control resource set (CORESET), and
monitor a second PDCCH in a second monitoring occasion, based on the first TCI state, in a first CORESET, in a case where the second monitoring occasion is overlapping with the first monitoring occasion,
wherein, the second CORESET is associated only with user equipment (UE) specific search space, and the first CORESET is associated with at least one common search space.

35: The terminal device of claim 34, wherein:
the second CORESET is associated with a physical cell ID of a serving cell, and the first CORESET is associated with another physical cell ID different from the physical cell ID of the serving cell.

36: The terminal device of claim 34, wherein:
both the first CORESET and the second CORESET are configured with a same quasi co-location (QCL) type, the same QCL type comprises a spatial receiver (Rx) parameter.

37: The terminal device of claim 34, wherein
a demodulation reference signal (DMRS) antenna port for the first PDCCH is quasi co-located with at least one RS configured in the second TCI state; and
a DMRS antenna port for the second PDCCH is quasi co-located with at least one RS configured in the first TCI state.

38: A network device, comprising a processor configured to cause the network device to:
transmit, to a terminal device, a first transmission configuration indicator (TCI) state and a second TCI state,
wherein:
the second TCI state is used for monitoring a first physical downlink control channel (PDCCH) in a first monitoring occasion, in a second control resource set (CORESET), and
the first TCI state is used for monitoring a second PDCCH in a second monitoring occasion, in a first CORESET, in a case where the second monitoring occasion is overlapping with the first monitoring occasion,
wherein, the second CORESET is associated only with user equipment (UE) specific search space, and the first CORESET is associated with at least one common search space.

39: The network device of claim 38, wherein:
the second CORESET is associated with a physical cell ID of a serving cell, and the first CORESET is associated with another physical cell ID different from the physical cell ID of the serving cell.

40: The network device of claim 38, wherein:
both the first CORESET and the second CORESET are configured with a same quasi co-location (QCL) type, the same QCL type comprises a spatial receiver (Rx) parameter.

41: The network device of claim 38, wherein
a demodulation reference signal (DMRS) antenna port for the first PDCCH is quasi co-located with at least one RS configured in the second TCI state; and
a DMRS antenna port for the second PDCCH is quasi co-located with at least one RS configured in the first TCI state.
